(19) United States
(12) Patent Application Publication
(10) Pub. No.: US 2025/0106581 A1
(43) Pub. Date: Mar. 27, 2025

(54) DYNAMICALLY UPDATING SIMULATED SOURCE LOCATIONS OF AUDIO SOURCES

(71) Applicant: Apple Inc., Cupertino, CA (US)

(72) Inventors: Gregory LUTTER, Boulder Creek, CA (US); Robert T. HELD, Seattle, WA (US); Luis R. DELIZ CENTENO, Fremont, CA (US)

(21) Appl. No.: 18/889,224

(22) Filed: Sep. 18, 2024

Related U.S. Application Data
(60) Provisional application No. 63/663,595, filed on Jun. 24, 2024.
(60) Provisional application No. 63/585,521, filed on Sep. 26, 2023.

(51) Int. Cl. H04S 7/00; H04R 1/32

(52) U.S. Cl. CPC H04S 7/302; H04R 1/323

(57) ABSTRACT

Some examples of the disclosure are directed to systems and methods for dynamically updating simulated source locations of audio sources within spatialized audio content based on detection of a change in the location and/or orientation of an audio output device (e.g., earbuds or speakers that are optionally worn by a user and are optionally included in a headset). In some examples, the simulated source locations are updated if the change in the location and/or orientation of the audio output device is greater than a threshold amount of change, and the simulated source locations are not updated if the change in the location and/or orientation of the audio output device is not greater than the threshold amount of change. In some examples, a simulated source location is identified in a three-dimensional environment. In some examples, a mode of outputting audio is changed in response to movement of an electronic device.

### CROSS-REFERENCE TO RELATED APPLICATIONS

This application claims the benefit of U.S. Provisional Application No. 63/663,595, filed Jun. 24, 2024, and U.S. Provisional Application No. 63/585,521, filed Sep. 26, 2023, the contents of which are herein incorporated by reference in their entireties for all purposes.

### FIELD OF THE DISCLOSURE

This relates generally to systems and methods for updating, based on a change in a location and/or orientation of an audio output device in a physical environment, one or more simulated source locations of audio content during playback of the audio content.

### BACKGROUND OF THE DISCLOSURE

Some computer graphical environments provide two-dimensional and/or three-dimensional environments where at least some objects displayed for a user's viewing are virtual and generated by a computer. In some examples, spatialized audio can be used to simulate a source location for audio content such that a user listening to the audio content perceives the audio content to be emanating from the simulated source location. In some cases, the user changes their location and/or orientation while listening to the audio content, such as when the user walks to another location and/or rotates their head and/or body.

### SUMMARY OF THE DISCLOSURE

Some examples of the disclosure are directed to systems and methods for dynamically updating a simulated source location of one or more audio sources included in spatialized audio content based on detection of a change in a pose of a user listening to the audio content and/or a change in a pose of an audio output device (e.g., earbuds, a speaker, headphones) that is optionally worn by the user.

Some examples of the disclosure are directed to systems and methods for determining a simulated source location from which to output audio content in an environment. In some examples, an electronic device contextually identifies a location within the environment from which to spatially output the audio content using one or more user inputs. In some examples, the simulated source location corresponds to a direction indicated by one or more input devices of the electronic device when an input to initiate output of the audio content is detected. In some examples, the simulated source location corresponds to a content recentering action performed by the electronic device.

Some examples of the disclosure are directed to systems and methods for changing a mode of output of audio content in an environment in response to a change in pose of an electronic device according to examples of the disclosure. In some examples, the electronic device changes the mode of output of the audio content in response to a change in pose of the electronic device that exceeds a threshold amount. In some examples, in response to the change in pose of the electronic device, the electronic device outputs the audio content with a fixed spatial relationship relative to a first portion of a user of the electronic device or relative to a first portion of the electronic device.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a device according to some examples of the disclosure.

FIG. 3A illustrates an example of outputting first and second audio content from simulated source locations according to some examples of the disclosure.

FIG. 3B illustrates an example of outputting first and second audio content from simulated source locations according to some examples of the disclosure.

FIG. 3C illustrates an example of outputting first and second audio content from simulated source locations according to some examples of the disclosure.

FIG. 3D illustrates an example of transitioning from outputting first and second audio sources from first simulated source locations to outputting the audio sources from second simulated source locations according to some examples of the disclosure.

FIG. 4 is an example flow diagram illustrating a method of dynamically updating audio simulated source locations according to some examples of the disclosure.

FIGS. 5A-5H illustrate an electronic device determining simulated source locations from which to output audio content in an environment according to examples of the disclosure.

FIG. 6 is an example flow diagram illustrating a method of determining a simulated source location from which to output audio content in an environment according to examples of the disclosure.

FIGS. 7A-7F illustrate an electronic device changing a mode of output of audio content in an environment in response to a change in pose of the electronic device according to examples of the disclosure.

FIG. 8 is an example flow diagram illustrating a method of changing a mode of output of audio content in an environment in response to a change in pose of the electronic device according to examples of the disclosure.

### DETAILED DESCRIPTION

Some examples of the disclosure are directed to systems and methods for dynamically updating, by an electronic device, a simulated source location of one or more audio sources included in spatialized audio content based on detection of a change in a pose (e.g., a change in location and/or orientation) of a user listening to the audio content and/or a change in a pose of an audio output device that is optionally worn by the user, such as a set of speakers, headphones, or earbuds.

Some examples of the disclosure are directed to systems and methods for determining a simulated source location from which to output audio content in an environment. In some examples, an electronic device identifies a location within the environment from which to spatially output the audio content. In some examples, the simulated source location corresponds to a direction indicated by one or more input devices of the electronic device when an input to initiate output of the audio content is detected. In some examples, the simulated source location corresponds to a content recentering action performed by the electronic device.

Some examples of the disclosure are directed to systems and methods for changing a mode of output of audio content in an environment in response to a change in pose of an electronic device according to examples of the disclosure. In some examples, the electronic device changes the mode of output of the audio content in response to a change in pose of the electronic device that exceeds a threshold amount. In some examples, in response to the change in pose of the electronic device, the electronic device outputs the audio content with a fixed spatial relationship relative to a first portion of a user of the electronic device or relative to a first portion of the electronic device.

Some electronic devices are configured to output audio content by transmitting the audio content to an audio output device and/or by transducing the audio content such that it is audible to a user of the electronic device. Such audio content can include pre-recorded music, podcasts, audio books, sound effects, movie or television audio content, or other types of audio content. In some cases, audio content can include multiple audio sources, such as multiple musical instruments, voices, or other sound sources. An electronic device optionally outputs the audio content as spatialized audio content such that audio sources in the audio content sound as though they are emanating from one or more simulated source locations around a user listening to the audio content. For example, the electronic device outputs one or more audio sources of the audio content from corresponding simulated source locations relative to the pose of the audio output device in the physical environment (which optionally corresponds to the pose of the user, such as if the user is wearing the audio output device). For example, the electronic device optionally adjusts one or more audio characteristics (such as volume, directionality, reverb, or other audio characteristics) associated with each audio source such that it sounds, to a user wearing the audio output device, as though each audio source is emanating from a corresponding simulated source location relative to the current location and orientation of the user in the physical environment.

As previously mentioned, the pose of the user and/or of the audio output device optionally includes, for example, a location and/or orientation (e.g., facing direction) of the user and/or of the audio output device within a three-dimensional physical environment. Optionally, the audio output device is included in (e.g., physically attached to and/or located within) the electronic device that is outputting the audio content, in which case the pose of the audio output device corresponds to (e.g., is based on) the pose of the electronic device. The pose of the user, electronic device, and/or audio output device can be detected via sensors, cameras, and/or other means, which are optionally included in the audio output device and/or in the electronic device. In some examples, the pose of the audio output device can be determined, by the electronic device, based on a detected pose of the user and/or of the electronic device, and vice versa. For brevity, much of the subsequent discussion refers to the pose of an audio output device but it should be understood that, additionally or alternatively, such description optionally applies to a pose of a user (e.g., a user listening to audio content via the audio output device while optionally wearing the audio output device) and/or to a pose of an electronic device that includes the audio output device (e.g., a headset that includes the audio output device and is optionally worn by the user).

In some examples, simulated source locations of audio sources are head-locked such that they move with the movement of the user's head (e.g., while the user is wearing an audio output device) and maintain a fixed spatial relationship with the user's head. In some examples, a head-locked simulated source location moves within the three-dimensional environment as the user's head moves such that the audio source always sounds, to the user, as though it is emanating from the same position relative to the user's current head position. For example, an audio source may always sound as though it is directly in front of the user regardless of the direction in which the user is looking. Head-locked audio sources may be undesirable in some scenarios, however. For example, the user may prefer to listen to music in a manner that simulates being in a room with musicians that remain stationary as the user moves within the environment, rather than sounding as though the musicians are moving with the user. Thus, in some examples, an electronic device maintains simulated source locations of audio sources at stationary locations rather than changing the simulated source locations in accordance with a change in the user's location and/or orientation, such as by tracking a position of a user's head and adjusting the audio characteristics of the audio sources accordingly such that they sound, to the user, as though they are stationary when the user moves within the environment. If the user moves relatively far from their initial location, however, the audio sources may begin to sound as though they are undesirably far away or have other undesirable acoustic properties. Alternatively, in some implementations, simulated source locations of audio sources are maintained relative to the user. For example, an orientation and a distance of the audio sources are maintained relative to the user, such that, as the user moves in their physical environment, the sound emitted from the audio sources is emanated at the same orientation and distance relative to the user (e.g., despite the user moving closer to or farther away from such simulated source locations). Thus, in some cases, it may be desirable for an electronic device to update the simulated source locations of the audio sources based on the user's new location and/or orientation.

As described herein, in some examples, if a user makes relatively small changes to their pose and/or to the pose of the audio output device within the physical environment of the user (e.g., by changing location and/or orientation by a relatively small amount, such as less than a threshold amount), the electronic device optionally continues to output the audio sources such that they sound as though they are emanating from the same simulated source locations (e.g., the simulated source locations remain stationary).

In some examples, if the user changes their pose and/or the pose of the audio output device by more than a threshold amount, however, the electronic device optionally changes the simulated source locations of the audio sources such that they sound, to the user, as though they are emanating from different simulated source locations.

In some examples, a spatial relationship between the pose of the user and/or of the audio output device and the simulated source location of an audio source is the same before and after the electronic device changes the simulated source location (e.g., before and after the user changes their pose by more than the threshold amount of change). For example, if an audio source initially sounds, to the user (e.g., when the user is in a first pose) as though it is emanating from a first simulated source location that is six feet away from the user along a vector that is at a 30-degree angle relative to a normal vector extending in front of the user, then optionally, after the electronic device changes the simulated source locations based on the change in the user's pose, the audio source still sounds to the user, when the user is in the second pose, as though the audio source is emanating from a source location that is six feet away from the user along a vector that is at a 30-degree angle relative to a normal vector extending in front of the user when the user is in the second pose. In some examples, the electronic device transitions from outputting the audio source from the first simulated source location to outputting the audio source from the second simulated source location by fading out (e.g., decreasing a volume of) the audio source at the first simulated source location and fading in (e.g., increasing a volume of) the audio source at the second simulated source location and/or by simulating a movement of the audio source from the first simulated source location to the second simulated source location (e.g., such that the audio source sounds, to the user, as though it is moving along a path from a first simulated source location to a second simulated source location).

In some examples, to avoid frequent changes of simulated source locations and potential confusion for the user, the electronic device waits until the user has remained stationary for a threshold time duration before updating the simulated source locations, and/or waits until a threshold time duration has elapsed since the last occurrence in which the electronic device changed the simulated source locations. For example, a user may change their pose (and that of an audio output device) by more than the threshold amount of change and then continue to change their pose by an additional amount (e.g., by continuing to walk, etc.). In this scenario, after detecting that the user has changed their pose by more than the threshold amount of change, the electronic device optionally waits until the user has become stationary (e.g., by remaining in or near a particular pose for a threshold time duration) before updating the simulated source location(s) based on the current pose of the user.

Additional details regarding dynamically updating simulated source locations of audio sources based on the detection of a change in a pose of an audio output device are provided below.

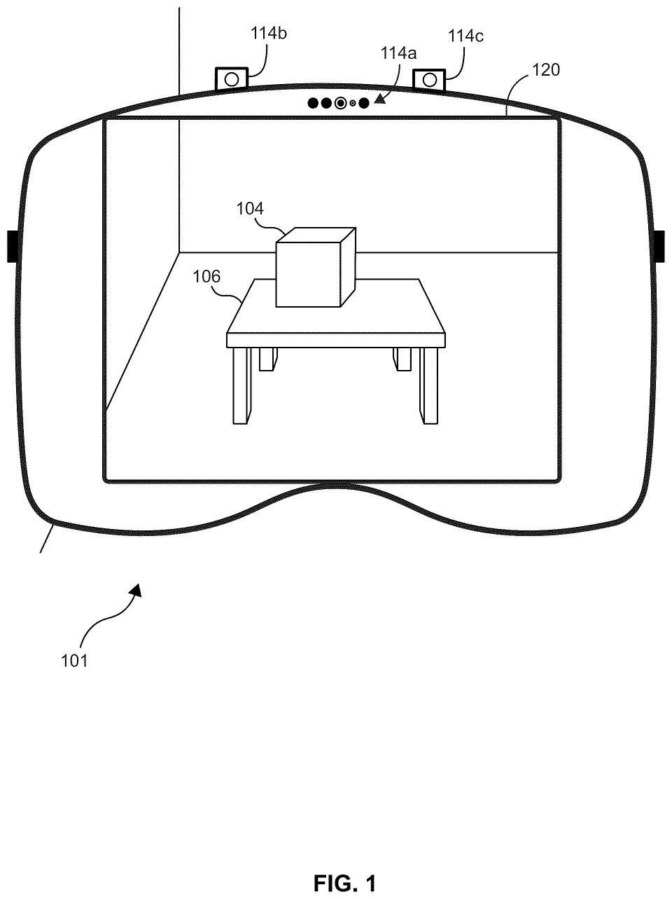

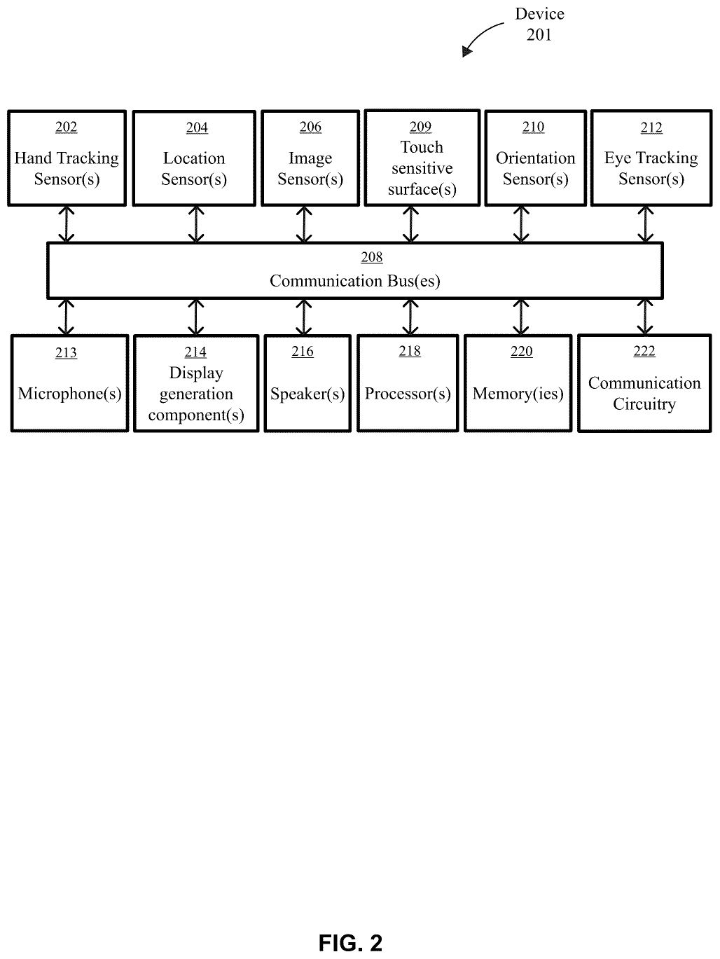

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a device 201 according to some examples of the disclosure. In some examples, device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216 (or other audio output device, such as a bone conduction device), one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positional system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., leg, torso, head, or hands of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

Attention is now directed towards techniques for dynamically updating a simulated source location of audio content based on a change in pose (e.g., location and/or orientation) of an audio output device, such as an audio output device that is optionally worn by a user listening to the audio content.

Some electronic devices are capable of outputting spatialized audio signals, in which audio content is processed to make it sound, to a user of the electronic device, as though audio sources of the audio content are emanating from various simulated source locations around the user. As described herein, in some examples, an electronic device updates the source locations of audio sources in response to detecting a change of more than a threshold amount in the pose of an audio output device that is optionally worn by the user.

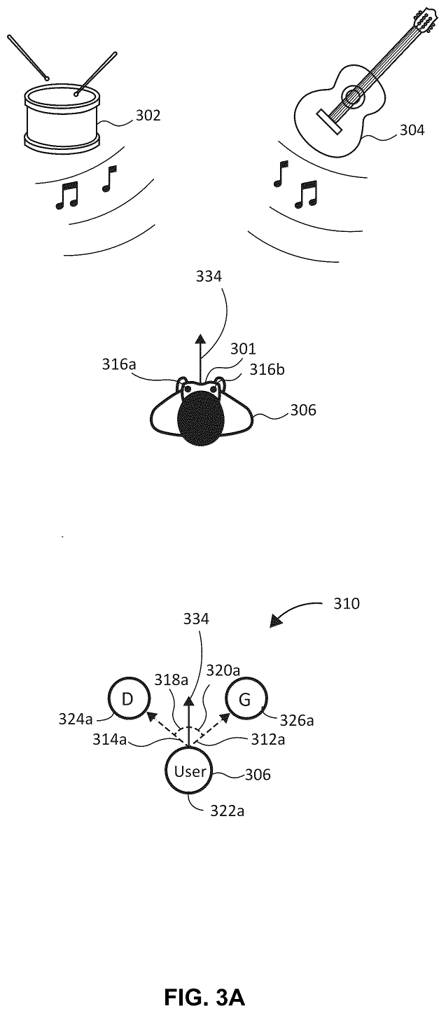

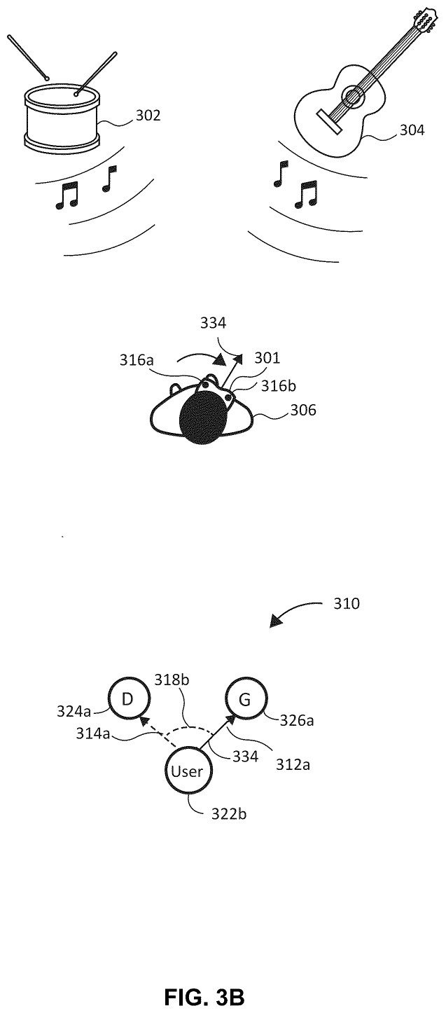

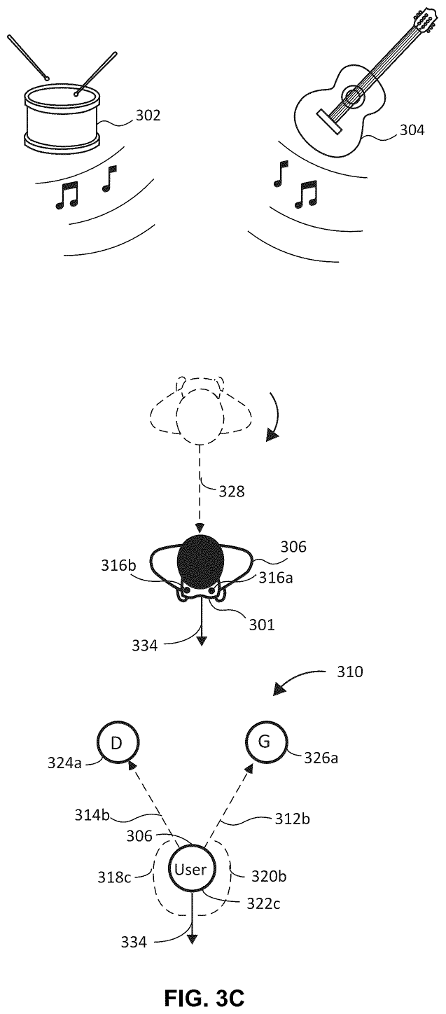

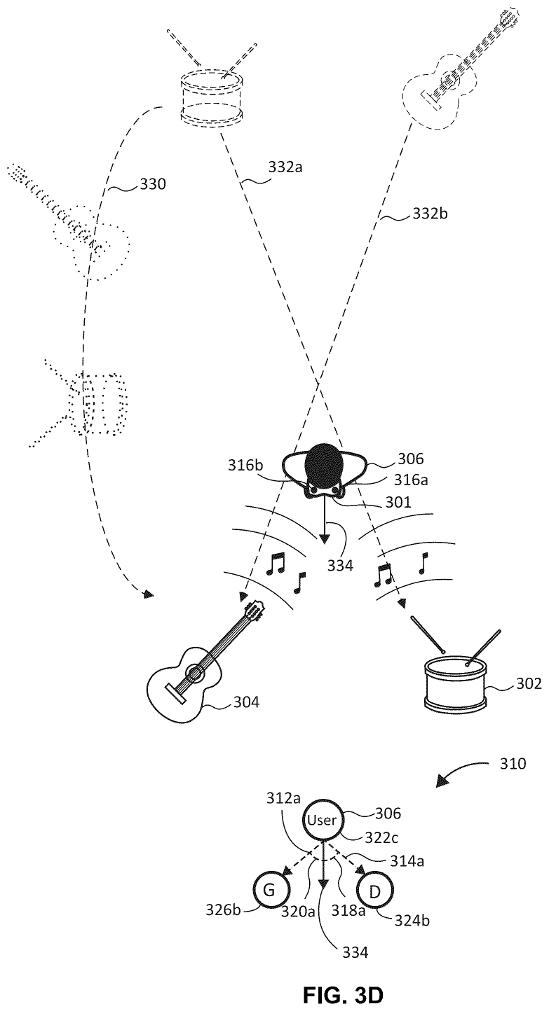

FIG. 3A illustrates an example of outputting first and second audio sources from first and second simulated source locations according to some examples of the disclosure.

In some examples, an electronic device detects a user input corresponding to a request to play pre-recorded audio content (such as music, a podcast, or other audio content associated with an application that is installed on the electronic device) that includes one or more audio sources (e.g., one or more musical instruments, voices, and/or other audio sources contained in the audio content). For example, the electronic device optionally detects a selection of an affordance associated with the audio content, such as touch on a touchscreen, an air gesture, a gaze direction, a click, or another type of input. Optionally, the audio content is spatialized audio content that includes information that specifies a simulated source location and/or orientation for one or more of the audio sources, relative volumes of the one or more audio sources, and/or other acoustic properties of the one or more audio sources. Optionally, one or more of the audio sources in the audio content are associated with corresponding simulated source locations (e.g., locations from which the audio sources sound as though they are emanating) that can optionally be independently changed (e.g., one or more simulated source locations can be changed without changing one or more other simulated source locations).

In some examples, in response to detecting the request to play the audio content, the electronic device determines (e.g., identifies or selects) one or more simulated source locations and/or orientations (e.g., beamforming directions) and/or other acoustic properties corresponding to the one or more audio sources of the audio content to spatialize the audio content. For example, the electronic device optionally identifies simulated source locations for audio sources of the audio content based on information contained in the audio content, based on a current location and/or orientation of the electronic device and/or of the audio output device, based on a characteristic of a physical environment of the electronic device and/or of the audio output device (such as based on room acoustics of the physical environment and/or the locations of physical objects in the physical environment), based on relative simulated source location(s) of other audio source(s) in the audio content, and/or based on other criteria. In some examples, the electronic device outputs the spatialized audio content via an audio output device (e.g., a speaker or other type of audio output device that produces an audibly perceptible output).

FIG. 3A depicts a user 306 wearing an electronic device 301 (e.g., a headset corresponding to electronic device 101 and/or 201 as described with reference to FIGS. 1 and 2, respectively). Electronic device 301 includes an audio output device (e.g., speakers 316a and 316b, which are optionally examples of speakers 216 as described with reference to FIG. 2). In FIG. 3A, user 306 has requested, while the audio output device is in a first pose 322a (e.g., at a first location and/or first orientation within a physical environment, such as oriented in a direction indicated by a normal vector 334 that extends from a front or facing side of electronic device 301 and/or of user 306 in schematic view 310), to play music that includes a drum set source 302 and a guitar source 304. In response to detecting a user input corresponding to a request to play the music, the electronic device 301 determines, based on the first pose 322a (and optionally on other criteria, such as configuration settings associated with outputting the audio content), a first simulated source location 324a for the drum set source 302 and a second simulated source location 326a for the guitar source 304. The simulated source locations optionally correspond to physical locations in the physical environment of the audio output device or to virtual locations in a computer-generated environment that is generated and/or displayed by the electronic device 301. The electronic device outputs drum set source 302 (e.g., via the audio output device) from the first simulated source location 324a. For example, the electronic device 301 outputs drum set source 302 in a manner that causes drum set source 302 to sound, to a user 306 wearing electronic device 301, as though drum set source 302 is emanating from the first simulated source location 324a. The electronic device outputs guitar source 304 from the second simulated source location 324b (e.g., in a manner that causes the guitar source 304 to sound, to the user 306, as though it is emanating from the second simulated source location 326a). For example, the electronic device 301 optionally uses beamforming, application of a head-related transfer function (HRTF) or head-related impulse response (HRIR), or other audio processing techniques to simulate locations and/or orientations of drum set source 302 and guitar source 304 relative to the first pose 322a.

The simulated source locations of drum set source 302 and guitar source 304 optionally have a first spatial relationship and second spatial relationship (respectively) with the first pose 322a, thereby defining a spatial relationship with each other (e.g., a distance between the simulated source locations of drum set source 302 and guitar source 304). A spatial relationship optionally includes a (simulated) distance, orientation, and/or angle relative to first pose 322a. For example, as illustrated in schematic view 310, the first simulated source location 324a is a first distance 314a from a location of the first pose 322a and is at a first angle 318a relative to normal vector 334. The second simulated source location 326a is optionally a second distance 312a from the location of the first pose 322a and is at a second angle 320 relative to normal vector 334. The first simulated source location 324a and second simulated source location 326a are optionally a first distance from each other. In this scenario, the user may perceive that sounds from the drum set source 302 are emanating from in front of and to the left of the user 306, and that sounds from the guitar source 304 are emanating from in front of and to the right of the user 306. Additionally or alternatively, in some examples, the spatial audio is presented in an Ambisonics format (e.g., a full-sphere surround sound format in which simulated source locations are arranged on the horizontal plane as similarly discussed above but can also be positioned above and/or below the user 306). For example, the first simulated source location 324a may lie on the horizontal plane relative to the user (e.g., in front of and to the left of the user 306) and the second simulated source location 326a may lie on a vertical plane relative to the user (e.g., above or below the user 306).

In some examples, electronic device 301 is configured to detect a change in the pose of electronic device 301, of user 306, and/or of the audio output device, such as based on signals received from accelerometers, gyroscopes, cameras, and/or other sensors on electronic device 301, on the audio output device, and/or on other electronic devices (e.g., separate cameras). In some examples, if the amount of change in the pose is less than a threshold amount of change (e.g., in terms of distance, angle of rotation, and/or other physical or contextual metrics such as described in more detail with reference to method 400) the electronic device 301 continues to output the drum set source 302 and guitar source 304 from the same simulated source locations from which these audio sources were output before the electronic device 301 detected the change in pose; e.g., without updating the simulated source locations.

In the example of FIG. 3B, the user 306 has changed the pose of the audio output device (and the electronic device 301) from the first pose 322a to a second pose 322b (e.g., shown in the schematic view 310) by turning their head to the right relative to the orientation depicted in FIG. 3A. In this example, the user 306 has rotated their head to look in the direction of guitar source 304 (e.g., to look in the direction of second simulated location 326a), as indicated by the change in direction of normal vector 334. In this example, the orientation of the audio output device (and the electronic device 301) has changed by approximately 45 degrees of rotation relative to the orientation of the audio output device and electronic device 301 when the electronic device 301 began outputting the audio content as described with reference to FIG. 3A.

In this example, the change in pose is determined, by electronic device 301, to be less than a threshold amount of change, and thus electronic device 301 continues to output the drum set source 302 from the first simulated source location 324a and output the guitar source 304 from the second simulated source location 326a. Continuing to output the audio sources from the same source locations when the pose of the audio output device is changed includes changing the acoustic properties of drum set source 302 and/or guitar source 304 in accordance with the change in the pose of the audio output device, such that they continue to sound as though they are emanating from the same source locations. For example, electronic device 301 optionally increases a volume of guitar source 304 output by left speaker 316a (e.g., to simulate the effect of the user 306 turning towards guitar source 304), decreases a volume of drum set source 302 output by right speaker 316b (e.g., to simulate the effect of the user turning away from drum set source 302), and/or otherwise changes the acoustic properties of drum set source 302 and/or guitar source 304 to cause drum set source 302 and guitar source 304 to sound as though they are continuing to emanate from first simulated source location 324a and second simulated source location 326a, respectively. In this case, after the user 306 has rotated their head to the right to look in the direction of the simulated source location 326a of guitar source 304, the user 306 may perceive guitar source 304 as emanating from directly in front of the user 306 (e.g., at a 0 degree angle relative to normal vector 334), and the user 306 may perceive the drum set source 302 as emanating from farther to the left of the user 306 (e.g., at a larger second angle 318b relative to normal vector 334 than first angle 318a depicted in FIG. 3A, as shown in schematic view 310).

Maintaining the simulated source locations of the audio sources simulates the acoustics of the guitar source 304 and drum set source 302 as though these audio sources are real-world instruments that remain stationary as the user 306 turns their head.

In some examples, when electronic device 301 detects that a pose of the audio output device has changed by more than a threshold amount of change, the electronic device 301 updates the simulated source locations of the audio sources based on the new pose of the audio output device, such as described in more detail with reference to FIG. 3D. The threshold amount of change optionally includes a threshold distance (e.g., 0.01, 0.1, 0.5, 1, 3, 5, or 10 meters), a threshold amount of rotation (e.g., 5, 15, 30, 45, 90, or 120 degrees), and/or a change in a physical room in which the audio output device is located, optionally including a threshold change in room acoustics (e.g., if the user moves from a large living room to a small dining room). Optionally, when electronic device 301 detects that a pose of the audio output device has changed by more than a threshold amount of change, the electronic device 301 waits until the audio output device has remained at or near a stationary pose for at least a threshold time duration before updating the simulated source locations of the audio sources, such as depicted in FIG. 3C.

FIG. 3C depicts an example in which the user 306 has changed the pose of the audio output device from the first pose 322a shown in FIG. 3A to a third pose 322c, such as by rotating 180 degrees relative to the orientation of first pose 322a shown in FIG. 3A and walking a first distance 328 away from the location of first pose 322a depicted in FIG. 3A. In this example, the electronic device 301 determines that the pose of the audio output device has changed by more than the threshold amount of change, but the electronic device 301 determines that the audio output device has not remained at or near (e.g., within 0.01, 0.1, 0.3, 0.5, 1, or 5 meters and/or within 5, 15, 30, 45, or 90 degrees of rotation) the third pose 322c for a threshold time duration (e.g., 0.1, 1, 3, 5, 10, 60, or 360 seconds). In this scenario, electronic device 301 optionally continues to output the drum set source 302 from the first simulated source location 324a and the guitar source 304 from the second simulated source location 326a. For example, the electronic device 301 optionally changes the acoustics of the spatialized audio content in a manner that maintains the simulated source locations of the audio sources (e.g., the simulated source locations remain stationary), such as by decreasing a volume of drum set source 302 and/or guitar source 304 to simulate the user turning away and getting farther from drum set source 302 and/or guitar source 304.

Schematic 310 in FIG. 3C illustrates the idea that, after the user 306 has turned and walked away from drum set source 302 and/or guitar source 304, the user 306 may perceive drum set source 302 as emanating from behind and to the right of the user 306 (e.g., at a second distance 314b and second angle 318c relative to normal 316) and may perceive guitar source 304 as emanating from behind and to the left of the user 306 (e.g., at a third distance 312b and third angle 320b relative to normal 316). Again, such a technique simulates the acoustics of the guitar source 304 and drum set source 302 as though these audio sources were real-world instruments that remained at stationary locations as the user 306 turned and walked away from the simulated source locations of the audio sources. In some examples, if the spatial audio is being presented in an Ambisonics format (e.g., as discussed above), movement of the user 306 causes the drum set source 302 and/or guitar source 304 to appear to be rotated relative to the user 306 (e.g., such as along a sphere). For example, if the drum set source 302 is located above the user, the movement of the user 306 discussed above causes the drum set source 302 to be perceived as emanating from behind and above the user 306 (e.g., radial movement relative to normal 316).

Alternatively, in some examples, when the electronic device 301 determines that the pose of the audio output device is changing (e.g., the user 306 is changing locations) but has not changed by more than a threshold amount of change, the electronic device 301 updates the simulated source locations of the drum set source 302 and the guitar source 304 to sound as though the audio sources are “following” the movement of the user 306, such as by updating, in accordance with the changing location of the user, the simulated source locations of the audio sources as the user 306 and/or audio output device to maintain a fixed distance from the user 306 and/or audio output device. For example, the simulated source location of the drum set source 302 and guitar source 304 remain at a fixed distance behind the current pose of the user 306 after the user 306 begins walking away from the simulated source locations. In this case, the electronic device 301 optionally does not maintain (e.g., changes) the spatial relationships between the simulated source locations and the current pose of the user 306 as the user 306 moves within the environment, which is different from the head-locked approach. For example, the angles between normal vector 334 and the simulated source locations of the drum set source 302 and guitar source 304 are optionally different than that shown in FIG. 3A, because the simulated source locations are behind the user 306 rather than in front of the user 306.

FIG. 3D depicts an example in which the user 306 has changed their pose (and that of the audio output device) as described with reference to FIG. 3C and has remained at or near (e.g., within a threshold distance of and/or within a threshold angle of) the third pose 322c for a threshold time duration. In this scenario, the electronic device 301 optionally determines new simulated source locations for drum set source 302 and/or guitar source 304 based on the third pose 322c of the audio output device, such as by re-centering the audio sources with respect to the third pose 322c.

For example, the electronic device 301 optionally selects, based on the third pose 322c, a third simulated source location 324b from which to output the drum set source 302 and a fourth simulated source location 326b from which to output the guitar source 304 relative to the third pose 322c. The electronic device 301 optionally transitions from outputting the drum set source 302 from the first simulated source location 324a to the third simulated source location 324b, and transitions from outputting the guitar source 304 from the second simulated source location 326a to the fourth simulated source location 326b. Optionally, the third simulated source location 324b and fourth simulated source location 326b have the same spatial relationship with the third pose 322c as the first simulated source location 324a and second simulated source location 326a had with the first pose 322a in FIG. 3A. For example, as shown in schematic view 310 in FIG. 3D, the third simulated source location 324b is the first distance 314a from a location of the third pose 322c and is at the first angle 318a relative to normal vector 334. Additionally, the fourth simulated source location 326b is the second distance 312a from the location of the third pose 322c and is at the second angle 320a relative to normal vector 334. In this case, like in FIG. 3A, the user may perceive that sounds from the drum set source 302 are emanating from in front of and to the left of the user 306, and that sounds from the guitar source 304 are emanating from in front of and to the right of the user 306, as illustrated by schematic view 310 in FIG. 3D.

In some examples, the electronic device 301 transitions from outputting the audio sources from the initial simulated source locations to new simulated source locations by fading out the audio sources at the initial simulated source locations and, serially or concurrently, fading in the audio sources at the new simulated source locations. In the example of FIG. 3D, the electronic device optionally fades out (e.g., reduces the volume of) the drum set source 302 at the first simulated source location 322a (shown in FIG. 3A) until the volume reaches zero (e.g., until the electronic device 301 ceases to output the drum set source 302 from the first source location 322a) and, serially or concurrently with the fading out, the electronic device 301 optionally fades in (e.g., increases the volume of) the drum set source 302 at the third simulated source location 324b until the electronic device 301 outputs the drum set source 302 from the third simulated source location 324b at a final volume level (e.g., a volume level after which the volume is no longer increased, which is optionally the volume at which the drum set source 302 was output prior to the transition). Similarly, the electronic device optionally fades out the guitar source 304 at the second simulated source location 324a and fades in the guitar source 304 at the fourth simulated source location 324b until the electronic device 301 outputs the guitar source 304 from the fourth simulated source location 326b at a final volume level (e.g., a volume level at which the guitar source 304 was output prior to the transition). Optionally, the electronic device 301 concurrently fades out the drum set source 302 and the guitar source 304 and/or concurrently fades in the drum set source 302 and the guitar source 304 during the transition.

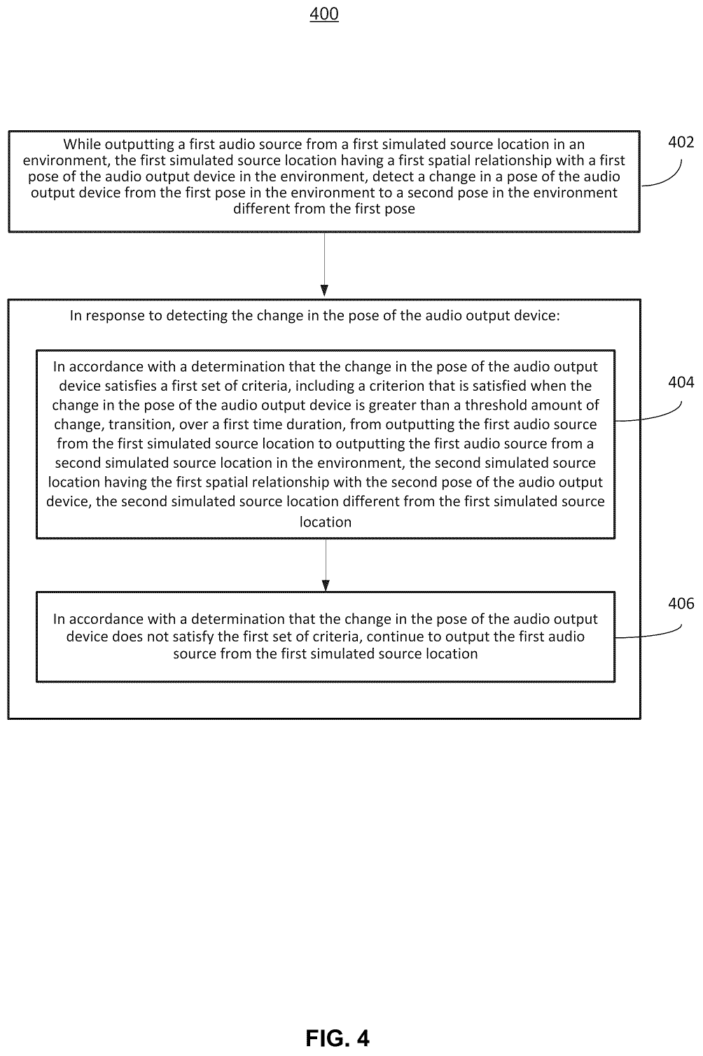

Additionally or alternatively, in some examples, the electronic device 301 transitions from outputting the audio sources from the initial simulated source locations to the new simulated source locations by simulating an auditory movement of the simulated source locations along a path (or paths), such as along an arc 330 (or other curved path) as shown in FIG. 3D, such that it sounds, to the user 306, as though the audio sources are moving from the initial simulated source locations to the new simulated source locations along the path, optionally including a simulated rotation of the audio sources relative to each other and/or relative to the user 306. Optionally, the curved path does not intersect the third pose 322c (e.g., the audio sources sound as though they are travelling around the user 306). Optionally, simulated source locations for different audio sources move along different paths. For example, in FIG. 3D, the simulated source location for drum set source 302 optionally moves along line 332a and the simulated source location for guitar source 304 optionally moves along line 332b. Optionally, the electronic device 301 maintains a spatial relationship (e.g., a distance and/or orientation) between the simulated source locations of the audio sources during the transition such that they sound, to the user 306, as though they are moving as a group. Optionally, the electronic device 301 changes a spatial relationship between the audio sources and the current pose of the audio output device during the transition, such as by changing a distance between the simulated source locations of the audio sources and the location of the audio output device. In the example of FIG. 3D, drum set source 302 and guitar source 304 optionally sound to the user 306, during the transition, as though they move closer to the user 306 (e.g., as the simulated source locations move along arc 330 or lines 332a and 332b) and/or as though they change their respective angles with respect to the normal vector 334 during the transition. Additionally or alternatively, in some examples, the electronic device 301 ducks the audio during the transition, such that, during the transition, an output level (e.g., volume) of the audio output device sounds quieter to the user 306, and when the transition is complete (or nearly complete), the output level is returned to the previous (e.g., default) output level. Additional details regarding methods for updating audio simulated source locations are described with reference to FIG. 4.

FIG. 4 illustrates a flow diagram for a method 400 of dynamically updating audio simulated source locations according to some examples of the disclosure. In some examples, method 400 begins at an electronic device in communication with (e.g., including and/or communicating signals with) an audio output device. In some examples, the electronic device is optionally a head-mounted device similar to or corresponding to device 201 of FIG. 2, and the audio output device corresponds to one or more speakers included in the electronic device, such as speakers 216 of FIG. 2. In some examples, the electronic device is another type of device, such as a phone, tablet, laptop computer, audio transceiver, or television, and the audio output device includes headphones or earbuds in communication with the electronic device.

At block 402, while the electronic device is outputting, via the audio output device, a first audio source (e.g., drum set source 302 of FIG. 3A) from a first simulated source location (e.g., simulated source location 324a of FIG. 3A) in an environment (e.g., from a simulated location within a three-dimensional physical environment), the first simulated source location having a first spatial relationship with a first pose of the audio output device in the environment (e.g., having a first distance from and/or orientation relative to a first location and/or orientation of the audio output device), the electronic device detects a change in a pose of the audio output device from the first pose in the environment to a second pose in the environment different from the first pose. For example, the electronic device detects a change in the pose of the audio output device from first pose 322a shown in FIG. 3A to second pose 322b shown in FIG. 3B or third pose 322c shown in FIGS. 3C and 3D, such as by detecting a change in the location and/or orientation of the audio output device (and/or of user 306 or electronic device 301) relative to the location and/or orientation of the first pose 322a. Optionally, the electronic device detects the change in the pose of the audio output device using sensors (e.g., accelerometers or other sensors) and/or cameras that are included the electronic device, and/or using signals received from the audio output device (e.g., if the audio output device includes sensors that are configured to sense a location and/or orientation of the audio output device).

At block 404, in response to detecting the change in the pose of the audio output device and in accordance with a determination that the change in the pose of the audio output device satisfies a first set of criteria, including a criterion that is satisfied when the change in the pose of the audio output device is greater than a threshold amount of change (such as described with reference to FIGS. 3C and 3D), the electronic device transitions, over a first time duration (e.g., over 0.1, 0.5, 1, 3, 5, 10, or 20 seconds), from outputting the first audio source from the first simulated source location to outputting the first audio source from a second simulated source location in the environment, the second simulated source location having the first spatial relationship with the second pose of the audio output device, the second simulated source location different from the first simulated source location. For example, the electronic device transitions from outputting the drum set source 302 from first simulated source location 324a in FIG. 3A to outputting the drum set source 302 from third simulated source location 324b in FIG. 3D.

In some examples, the first set of criteria includes a criterion that is satisfied when the audio output device remains within a threshold distance and/or angle of the second pose for a threshold time duration, such as described with reference to FIGS. 3C and 3D. In some examples, the first set of criteria includes a criterion that is satisfied when the electronic device has maintained the simulated source location of the first audio source (e.g., at the same simulated source location) for a threshold time duration, such as for 1, 5, 10, 30, 60, 360, or 520 seconds (e.g., the simulated source location of the audio source has remained at the first simulated source location for the threshold time duration).

At block 406, in response to detecting the change in the pose of the audio output device and in accordance with a determination that the change in the pose of the audio output device does not satisfy the first set of criteria (e.g., because one or more criteria of the first set of criteria are not satisfied), the electronic device continues to output the first audio source from the first simulated source location, such as described with reference to FIGS. 3B and 3C.

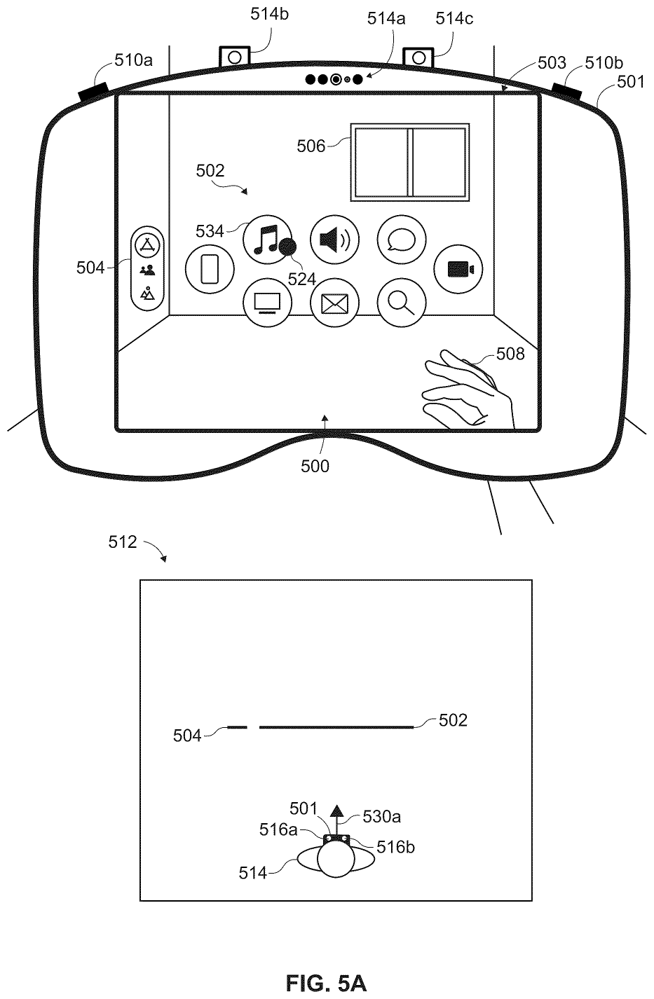

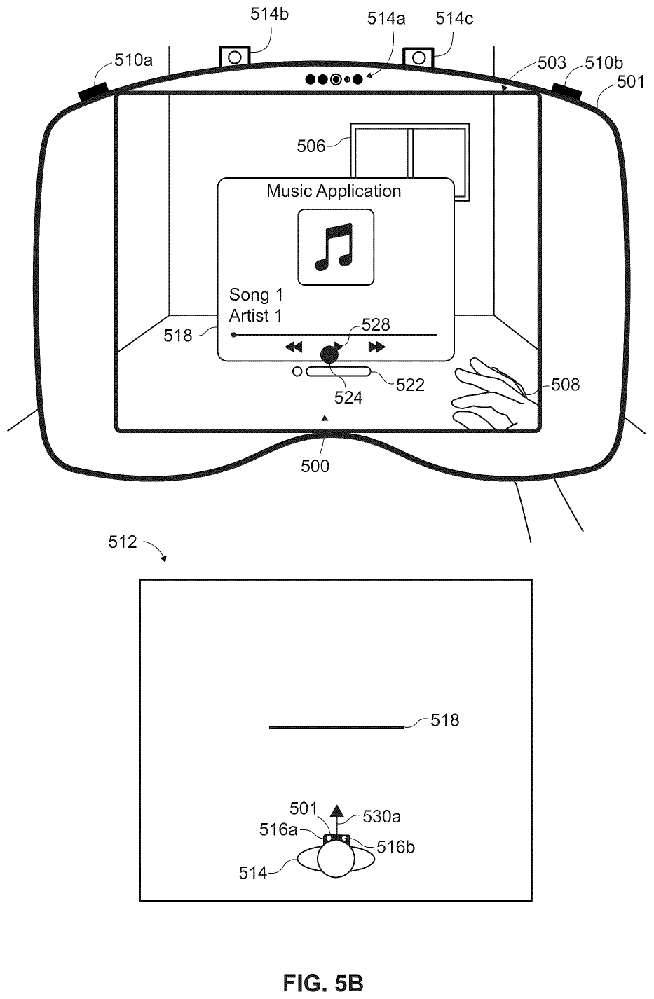

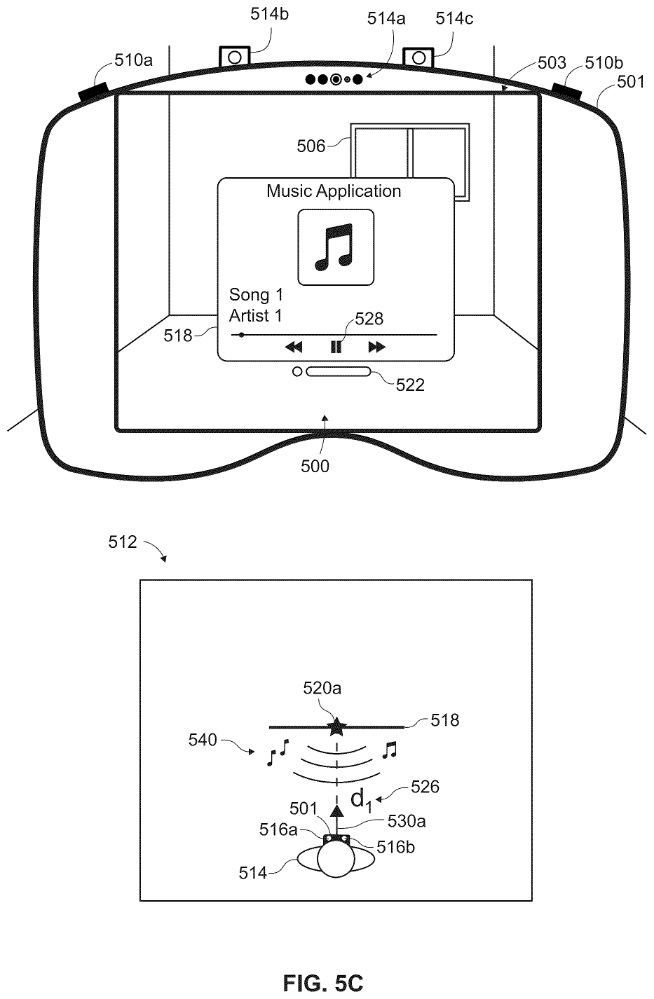

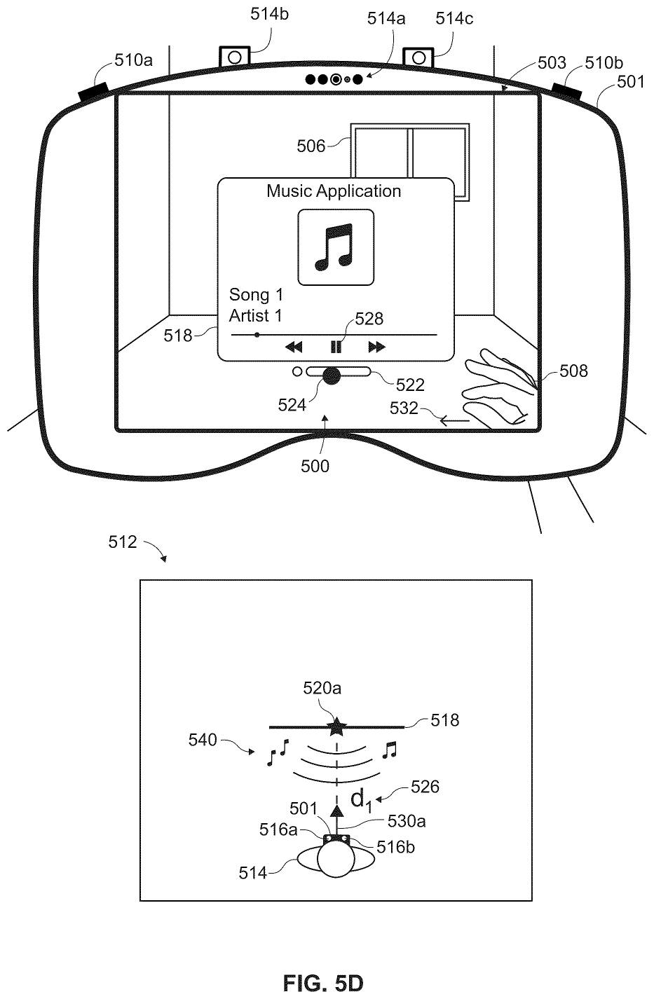

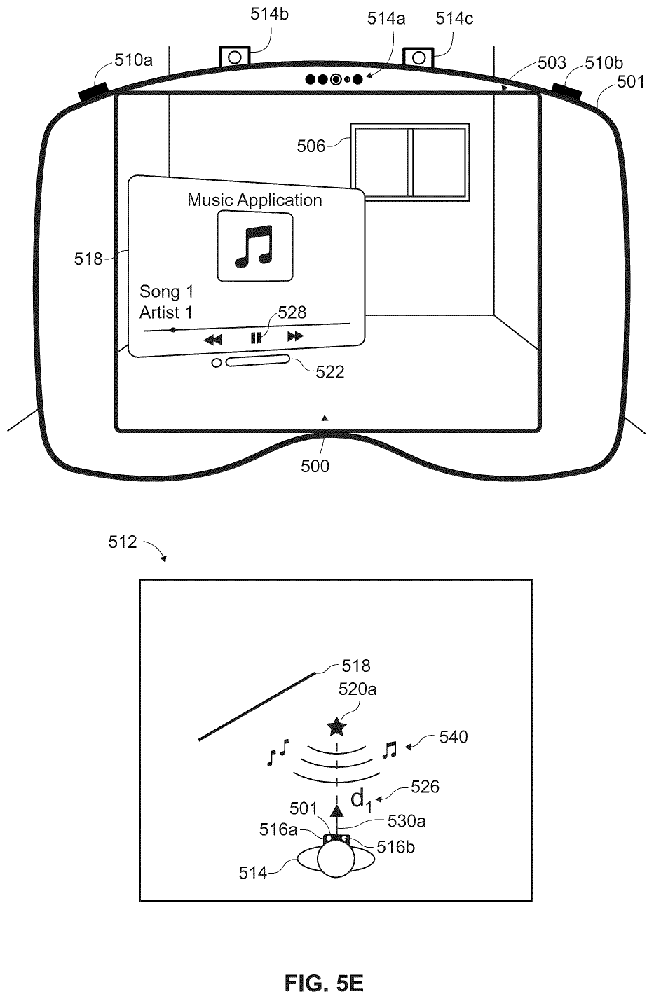

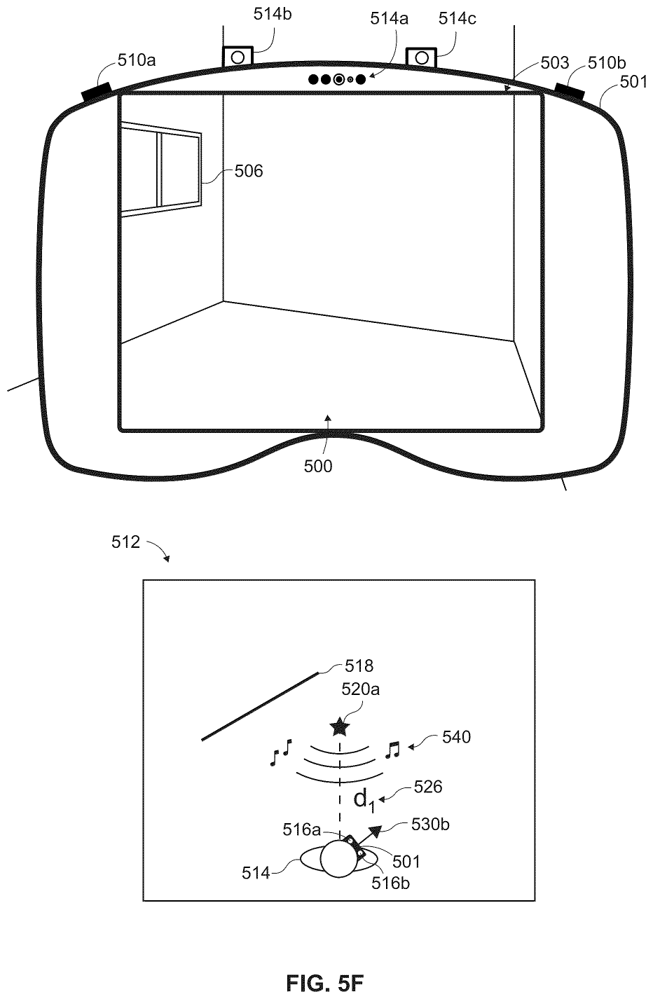

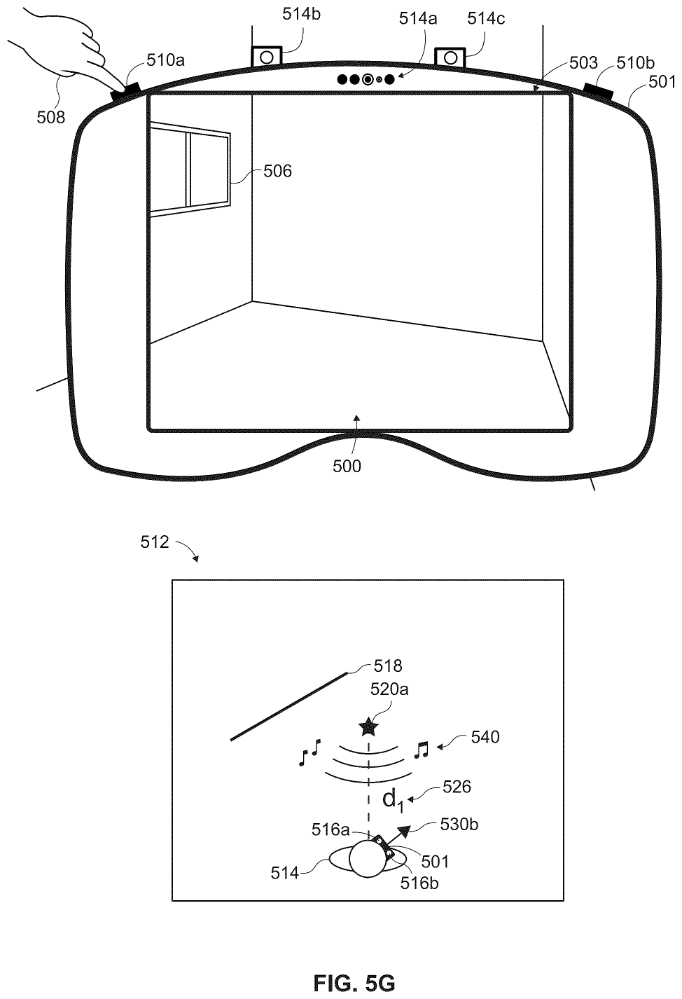

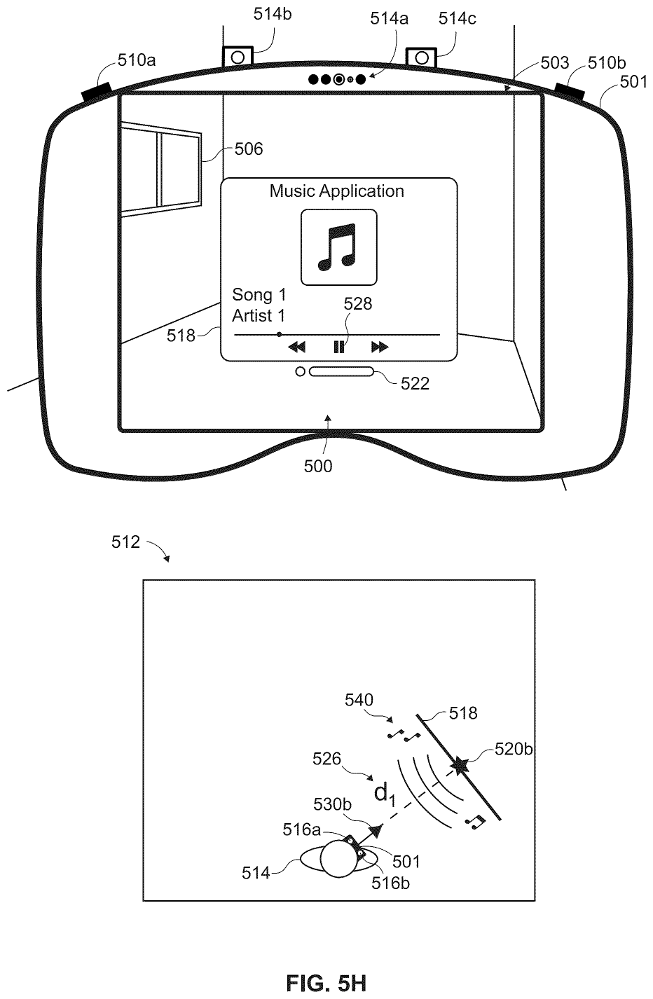

FIGS. 5A-5H illustrate an electronic device determining simulated source locations to output audio content from in an environment according to examples of the disclosure.

In some examples, the electronic device determines a location in the environment from which to simulate output of the audio content in response to one or more user inputs. For example, a simulated source location is determined based on a direction indicated by one or more user input devices of the electronic device while an input corresponding to a request to output the first audio content is detected. The direction indicated by the one or more input devices optionally corresponds to a direction of attention (e.g., gaze) of the user of the electronic device, and/or a pose of the electronic device relative to the environment (e.g., a forward direction of the electronic device in the environment). For example, a simulated source location is determined in response to an input corresponding to a request to perform a recentering action in the environment. The recentering action optionally includes repositioning virtual (e.g., visual) and/or audio content in the environment relative to a current viewpoint of the user of the electronic device (e.g., performing the recentering action includes changing a current (e.g., at the time of recentering action) simulated source location of the audio content from a first simulated source location that includes a first spatial arrangement (e.g., location and/or orientation) relative to the user of the electronic device in the environment to a second simulated source location that includes a second spatial arrangement, different from the first spatial arrangement, relative to the user of the electronic device in the environment). By identifying a simulated source location in the environment, the electronic device reduces (e.g., minimizes) the number of user inputs that are required to play back the audio content in the environment (e.g., by automatically setting and/or changing the simulated source location of the audio content and limiting the need to manually set the simulated source location). Thus, by reducing the number of inputs, the user interaction and user experience can be improved.

FIGS. 5A-5H illustrate an electronic device 501. In some examples, electronic device 501 has one or more characteristics of electronic device 101, 201 and/or 301 described above. In some examples, electronic device 501 is a wearable device including a display generation component 503 (e.g., electronic device 501 is a head-mounted display including one or more displays). In some examples, display generation component 503 includes one or more displays that have one or more characteristics of display generation component(s) 214 described with reference to FIG. 2. In some examples, electronic device 501 includes one or more image sensors (e.g., having one or more characteristics of image sensors 114a-114c and/or image sensor(s) 206 described above) configured to detect a physical environment (e.g., having one or more characteristics of a real-world environment and/or a physical environment described above) of user 514 and/or movement of one or more portions (e.g., hands, head, and/or eyes) and/or attention (e.g., gaze) of user 514. In some examples, electronic device 501 includes audio output devices 516a-516b (shown in overhead view 512). In some examples, audio output devices 516a-516b have one or more characteristics of audio output devices 316a-316b shown and described with reference to FIGS. 3A-3D and/or speakers 216 described with reference to FIG. 2. In some examples, electronic device 501 includes one or more hardware input devices. For example, electronic device 501 includes hardware buttons 510a-510b that can be actuated by user 514 (e.g., while wearing electronic device 501). In some examples, the one or more hardware input devices include one or more buttons, knobs, dials, switches, crowns, touchscreens (e.g., touch-sensitive display), trackpads, and/or keyboards.

In some examples, an environment 500 is visible to a user 514 (shown in overhead view 512) of electronic device 501. In some examples, environment 500 is a three-dimensional environment that is presented to user 514 via display generation component 503. In some examples, environment 500 is an extended reality (XR) environment having one or more characteristics of an XR environment described above. For example, from a current viewpoint of user 514, one or more virtual elements (e.g., home user interface 502 and/or menu 504 shown in FIG. 5A) are presented in environment 500 while one or more physical objects (e.g., real-world window 506 shown in FIG. 5A) from a physical environment of user 514 are visible (e.g., within video passthrough or optical see-through of the physical environment of user 514). In some examples, environment 500 is a virtual reality environment (e.g., environment 500 is fully or partially immersive (e.g., user 514 controls a level of immersion through one or more input devices of electronic device 501)).

FIGS. 5A-5H include an overhead view 512 of environment 500. Overhead view 512 includes a representation of user 514 wearing electronic device 501. In FIGS. 5A-5H, virtual elements included within environment 500 (and optionally visible through display generation component 503) are illustrated in overhead view 512 (e.g., locations of the virtual elements change in overhead view 512 as they are moved by electronic device 501 in environment 500 (e.g., in response to user input)). For example, in FIG. 5A, overhead view 512 includes a representation of home user interface 502 and menu 504 that are presented by electronic device 501 in environment 500 (via display generation component 503).

Overhead view 512 additionally includes a schematic representation of a current pose of electronic device 501 (represented by an arrow extending from electronic device 501). For example, in FIG. 5A, electronic device 501 includes a pose 530a relative to environment 500. In some examples, a change in pose of electronic device 501 is reflected in overhead view 512 through a change in orientation of the current pose (e.g., from pose 530a shown in FIG. 5A to pose 530b shown in FIG. 5F). In some examples, the current pose of electronic device 501 (e.g., pose 530a in FIG. 5A) corresponds to a current viewpoint of user 514 (e.g., a change in the current pose of electronic device 501 corresponds to a change in the current viewpoint of user 514 relative to environment 500). In some examples, the current pose of electronic device 501 corresponds to a forward direction of electronic device 501 in environment 500 (e.g., the forward direction corresponds to a vector normal to a center of a front surface of electronic device 501). In some examples, electronic device 501 determines the pose of electronic device 501 relative to environment 500 using one or more input devices (e.g., image sensor(s) 206 and/or orientation sensor(s) 210).

FIG. 5A illustrates electronic device 501 presenting a home user interface 502 in environment 500 according to examples of the disclosure. In some examples, home user interface 502 includes a plurality of icons (e.g., icon 534) corresponding to one or more applications accessible to user 514 through electronic device 501. For example, in response to a user input corresponding to selection of an icon of the plurality of icons included in home user interface 502, electronic device 501 presents (e.g., via display generation component 503), a user interface of an application (e.g., a messaging application, social media application, video streaming application, video conferencing application etc.). In some examples, one or more system settings are accessible through home user interface (e.g., audio output volume). In some examples, as shown in FIG. 5A, home user interface 502 includes a menu 504. In some examples, menu includes one or more selectable options for changing the presentation of the plurality of icons in home user interface 502. For example, selection of a selectable option included in menu 504 presents one or more icons corresponding to one or more virtual environments that are accessible to user 514 through electronic device 501 (e.g., the virtual environments are immersive environments that include representations of real-world locations (e.g., a beach scene, a mountain scene, a lake scene, etc.)).

In FIG. 5A, user 514 performs an input corresponding to selection of icon 534. In some examples, selection input includes attention of user 514 (e.g., based on gaze, cursor, and/or hand position) directed to icon 534 while a hand gesture is performed. For example, as shown in FIG. 5A, the selection input includes an air pinch (e.g., bringing together and then releasing a thumb and index finger) performed by hand 508 while gaze 524 (which is schematically represented by a solid circle) of user 514 is directed to icon 534. In some examples, icon 534 is a representation of an audio and/or video streaming application (e.g., for streaming music). In some examples, in response to selection of icon 534, electronic device 501 presents a user interface of the audio and/or video streaming application.

FIG. 5B illustrates electronic device 501 presenting a user interface of an audio streaming application in an environment 500 according to examples of the disclosure. As shown in FIG. 5B, the user interface of the audio streaming application is presented within virtual window 518. In some examples, the user interface presented within virtual window 518 includes information associated with audio content that is accessible for playback through the audio streaming application (e.g., an album cover, a song name, and an artist name). In some examples, the user interface presented within virtual window 518 includes one or more playback controls for controlling output of the audio content, such as playback affordance 528. In some examples, playback affordance 528 is selectable to initiate output of audio content (e.g., via audio output devices 516a-516b) in environment 500. In some examples, the location of virtual window 518 in environment 500 corresponds to a pre-set (e.g., default, as defined by system settings of electronic device 501) location. In some examples, the location of virtual window 518 in environment 500 corresponds to a user-defined (e.g., stored in a user profile of user 514) location. In some examples, the location of virtual window 518 corresponds to a previous location of virtual window 518 was presented from and/or moved to by user 514 (e.g., during the last time the audio streaming application was launched and/or interacted with by user 514). In some examples, the location of virtual window 518 corresponds to a previous content recentering action (e.g., as shown and described with reference to FIGS. 5G-5H). For example, electronic device 501 presents virtual window 518 at a location in environment 500 and/or at a display location (e.g., relative to the current viewpoint of user 514) that virtual window 518 was moved to in response to a previous content recentering action (e.g., during a previous session the audio streaming application was used by user 514). In some examples, in response to an input corresponding to a request to output audio content associated with the audio streaming application in environment 500, electronic device 501 outputs audio content from a simulated source location corresponding to the location of virtual window 518 in environment 500. Outputting the audio content from a simulated source location corresponding to the location of virtual window 518 conserves computing resources by not requiring the user of electronic device 501 to perform additional inputs to set (e.g., manually) the output location of the audio content (e.g., because electronic device 501 automatically sets the simulated source location to correspond to the location of virtual window 518).

In some examples, virtual window 518 is presented with an affordance 522 for moving virtual window 518 in environment 500. For example, affordance 522 is selectable to change a location of virtual window 518 in environment 500 (e.g., as shown and described with reference to FIGS. 5D-5E).

In FIG. 5B, electronic device 501 detects an input corresponding to a request to output audio content in environment 500. As shown in FIG. 5B, the input corresponds to selection of playback affordance 528. In some examples, the input has one or more characteristics of the selection input described with reference to FIG. 5A. For example, in FIG. 5B, the input includes gaze 524 directed to playback affordance 528 while user 514 performs an air pinch with hand 508. Alternatively, in some examples, the input includes user 514 tapping (e.g., through an air tap) playback affordance 528 with a finger of hand 508.

FIG. 5C illustrates electronic device 501 outputting audio content in response to the input detected in FIG. 5B, according to examples of the disclosure. In some examples, after (e.g., in response to) detecting the input shown in FIG. 5B, electronic device 501 determines a simulated source location of the audio content based on a direction indicated by one or more input devices of electronic device 501. For example, the one or more input devices include orientation sensor(s) 210, image sensor(s) 206, and/or eye tracking sensor(s) 212 shown and described with reference to FIG. 2. In some examples, the simulated source location of the audio content corresponds to a direction of gaze 524 when the input corresponding to the request to output the audio content shown in FIG. 5B is performed. For example, electronic device 501 outputs the audio content (e.g., via audio output devices 516a-516b) as if the audio content is emanating from a direction where user 514 was looking when performing the input corresponding to the request to output the audio content. In some examples, the simulated source location of the audio content is determined based on the current pose of electronic device 501 relative to environment (e.g., electronic device 501 determines the simulated source location to output the audio content from in environment 500 using pose 530a of electronic device 501 shown in FIG. 5B). For example, the simulated source location of the audio content corresponds to a forward direction of electronic device 501 (e.g., the simulated source location is aligned with a center of (e.g., or within 0.1, 0.2, 0.5, 1, 2, 5, 10, 15, 20, 25, 30, 35, 40, or 45 degrees of center of) a front surface of electronic device 501 (e.g., a front surface of display generation component 503)). In some examples, the audio content is output from a simulated source location in environment 500 that is based on a combination of a direction of gaze 524 and the current pose (e.g., pose 530a) of electronic device 501.

In FIG. 5C, audio content 540 (shown in overhead view 512) is output (via audio output devices 516a-516b) from simulated source location 520a (schematically illustrated as a star in overhead view 512). In some examples, simulated source location 520a includes a spatial arrangement relative that includes a respective orientation and/or a distance. For example, the spatial arrangement defines an orientation and/or a distance audio content 540 is output from in environment 500 relative to a current pose of electronic device 501 (and/or relative to a location of user 514 in environment 500).

In some examples, the respective orientation of the spatial arrangement of simulated source location 520a is based on the direction of gaze 524 (shown in FIG. 5B) and/or the pose 530a of electronic device 501 when user 514 performed the input detected in FIG. 5B (e.g., as described above). For example, the orientation of simulated source location 520a relative to electronic device 501 and/or user 514 corresponds to the direction of gaze 524 and/or a forward direction of electronic device 501 at pose 530a when the input is performed to initiate output of audio content 540 in FIG. 5B. Identifying an orientation to output audio content 540 from relative to user 514 from a pose electronic device 501 and/or direction of gaze 524 (e.g., indicated by one or more input devices of electronic device 501) conserves computing resources by not requiring additional inputs to set (e.g., manually) the output orientation of audio content 540 (e.g., because electronic device 501 automatically identifies the orientation to output audio content 540 from in environment 500).

In some examples, the respective distance of the spatial arrangement of simulated source location 520a is defined by a fixed distance. For example, in FIG. 5C, electronic device 501 audio content 540 from a location that is a fixed distance 526 from electronic device 501 and/or user 514 in environment 500 (fixed distance 526 is illustrated in overhead view 512 by “d1” and a dashed reference line between the location in environment 500 corresponding to user 514 and simulated source location 520a). In some examples, fixed distance 526 is a pre-set distance (e.g., a default distance stored in system settings of electronic device 501). In some examples, fixed distance 526 is a user-defined distance (e.g., stored in a user profile). In some examples, fixed distance 526 is defined by a previous simulated source location audio content 540 was output from in environment 500 (e.g., during a previous session of user 514 using the audio streaming application). For example, during the last session user 514 used audio streaming application, audio content 540 was output at fixed distance 526 from the location of user 514 in environment 500. In some examples, electronic device 501 identifies simulated source location 520a based on a location of virtual window 518 in environment 500 when the output of audio content 540 was initiated. For example, electronic device 501 outputs audio content 540 from simulated source location 520a because it corresponds to the position (e.g., location and/or orientation) of virtual window 518 in environment 500 when the input to output of audio content 540 was detected by electronic device 501 in FIG. 5B. In some examples, simulated source location 520a is set by electronic device 501 independent from the presentation position (e.g., location and/or orientation) of virtual window 518 in environment 500. Outputting audio content 540 from an identified fixed distance in environment 500 relative to electronic device 501 and/or user 514 conserves computing resources by not requiring additional inputs to set (e.g., manually) the distance to output audio content 540 from in environment 500.

Alternatively, or additionally, in some examples, electronic device 501 identifies simulated source location 520a from a previous content recentering action performed in environment 500 (e.g., as described below with reference to FIGS. 5G-5H).

It should be appreciated that the schematic representations of simulated source location 520a, fixed distance 526, and audio content 540 shown in overhead view 512 are illustrated for reference, and do not correspond to virtual elements that are presented by electronic device 501 (via display generation component 503) in environment 500.

Alternatively, or additionally, to the examples illustrated in FIGS. 5A-5C, in some examples, electronic device 501 presents an affordance in environment 500 that is selectable to launch a media experience (e.g., in a user interface different from home user interface 502 shown in FIG. 5A (e.g., the affordance is different from icon 534)). For example, the affordance is selectable to join a communication session that includes sharing visual and/or audio content (e.g., a shared playback session). In some examples, in response to detecting selection of the affordance, electronic device 501 outputs audio content and/or presents a user interface associated with the media experience (e.g., having one or more characteristics of the user interface of the audio streaming application shown and described with reference to FIG. 5B) in environment 500. For example, the user interface is presented at a location in environment 500 that is user-defined (e.g., having one or more characteristics of presenting virtual window 518 at the user-defined location described with reference to FIG. 5B). For example, the user interface is presented at a location that is pre-set in environment 500 (e.g., having one or more characteristics of presenting virtual window 518 at the pre-set location described with reference to FIG. 5B) or whose location is otherwise determined by the operating system of the electronic device. For example, the simulated source location of the output of the audio content in environment 500 corresponds to the presentation position of the user interface in environment 500 (e.g., as described with reference to FIG. 5C).

In some examples, after determining a simulated source location associated with the audio streaming application (e.g., as shown and described with reference to FIG. 5C), the simulated source location remains in place following subsequent movement of the application. FIG. 5D illustrates electronic device 501 detecting an input corresponding to a request to change a location of virtual window 518 in environment 500 according to examples of the disclosure. In some examples, the input has one or more characteristics of the selection input described above (e.g., with reference to FIG. 5A). For example, as shown in FIG. 5D, the input includes gaze 524 directed to affordance 522 and an air pinch performed with hand 508. The gesture performed with hand 508 includes movement in a direction represented by arrow 532 (e.g., the movement of hand 508 occurs while user 514 is performing the air pinch). In response to the input detected by electronic device 501 (e.g., via hand tracking sensor(s) 202) in FIG. 5D, electronic device 501 moves virtual window 518 to a new location in environment 500, as shown in FIG. 5E.

FIG. 5E illustrates virtual window 518 moved to a new location in response to the input corresponding to the request to change the location of virtual window 518 according to examples of the disclosure. In some examples, the location of virtual window 518 in environment 500 illustrated in FIG. 5E corresponds to the movement (e.g., hand movement of hand 508) associated with the user input illustrated in FIG. 5D (e.g., electronic device 501 moves virtual window 518 to a location in environment 500 that corresponds to a direction and/or magnitude of movement of hand 508 included in the user input performed in FIG. 5D). In some examples, as shown in FIG. 5E, in response to the input corresponding to the request to change the location of virtual window 518, electronic device 501 maintains output of audio content 540 from simulated source location 520a in environment 500. Permitting user 514 to move virtual window 518 (and the user interface associated with the audio streaming application) without changing simulated source location 520a of audio content 540 provides user 514 discretion to move virtual window 518 to a new location (e.g., away from a center of the field of view of user 514) without impacting the output of audio content 540 (which improves user experience and user-device interaction by preventing unintended changes in the output of audio content 540, and limits battery consumption by limiting the need for corrective user inputs).

FIG. 5F illustrates a change in pose of electronic device 501 relative to environment 500 according to examples of the disclosure. As shown in FIG. 5F, electronic device 501 changes from pose 530a (shown in FIG. 5E) to pose 530b. The change in pose of electronic device 501 includes rotational movement of electronic device 501 (e.g., a change in orientation of electronic device 501 relative to environment 500). The change in pose of electronic device 501 shown from FIG. 5E to FIG. 5F does not include translational movement of electronic device 501 or includes less than a threshold amount of translational movement. Due to the change in pose of electronic device 501 (e.g., caused by user 514 turning their head to their right), the current viewpoint (e.g., and field of view) of user 514 changes. Accordingly, as shown in FIG. 5F, a different portion of environment 500 is visible to user 514 through display generation component 503. For example, as a result of the change in the current viewpoint of user 514, virtual window 518 is not visible to user 514 in FIG. 5F (e.g., virtual window 518 is outside of the current field of view of user 514). Permitting a change in pose of electronic device 501 (e.g., through rotational movement) without changing simulated source location 520a of audio content 540 provides user 514 discretion to view other portions of environment 500 without impacting the output location of audio content 540 (which improves user experience and user-device interaction by preventing unintended changes in the output of audio content 540, and limits battery consumption by limiting the need for corrective user inputs).

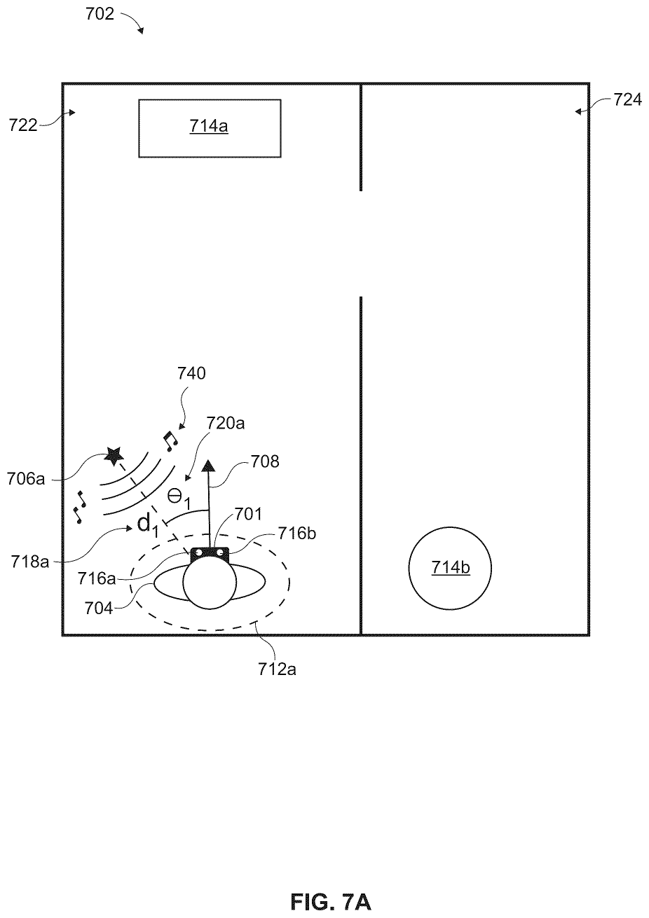

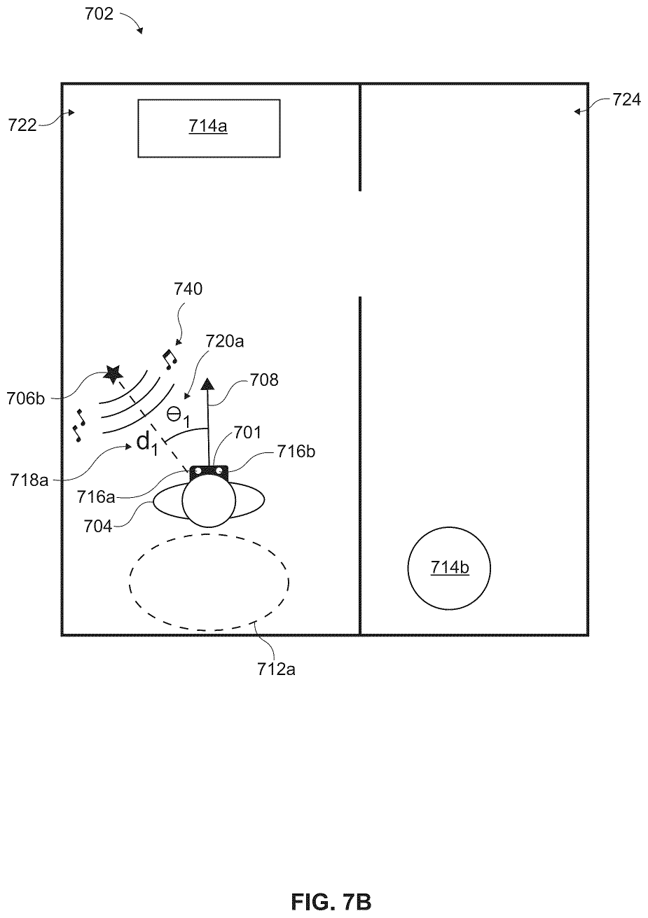

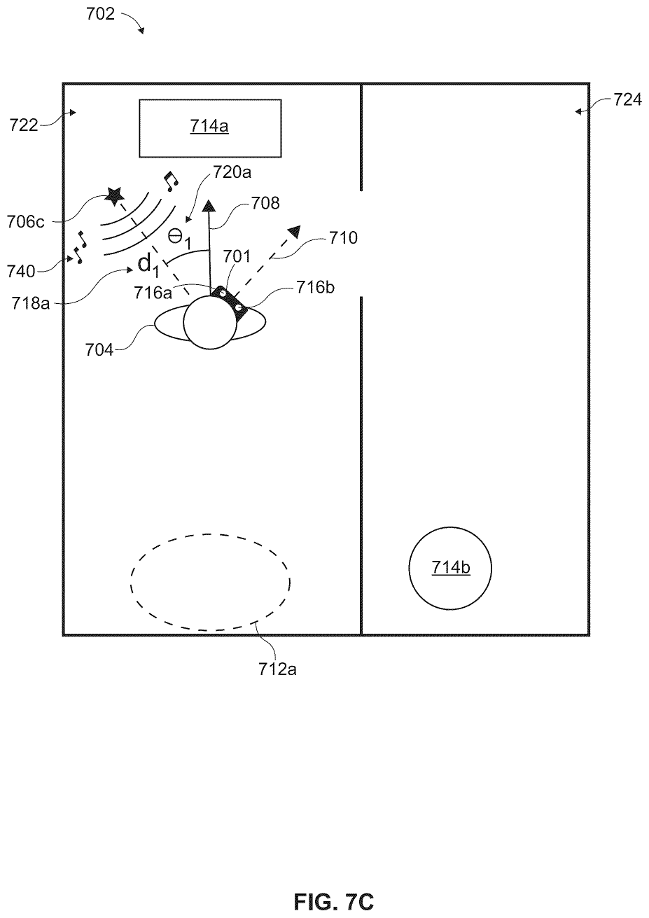

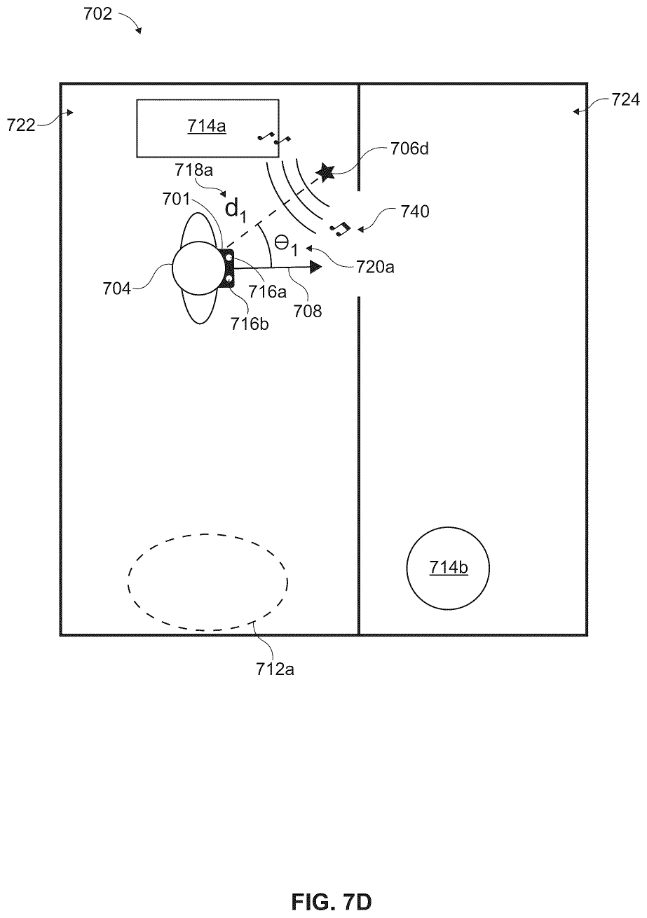

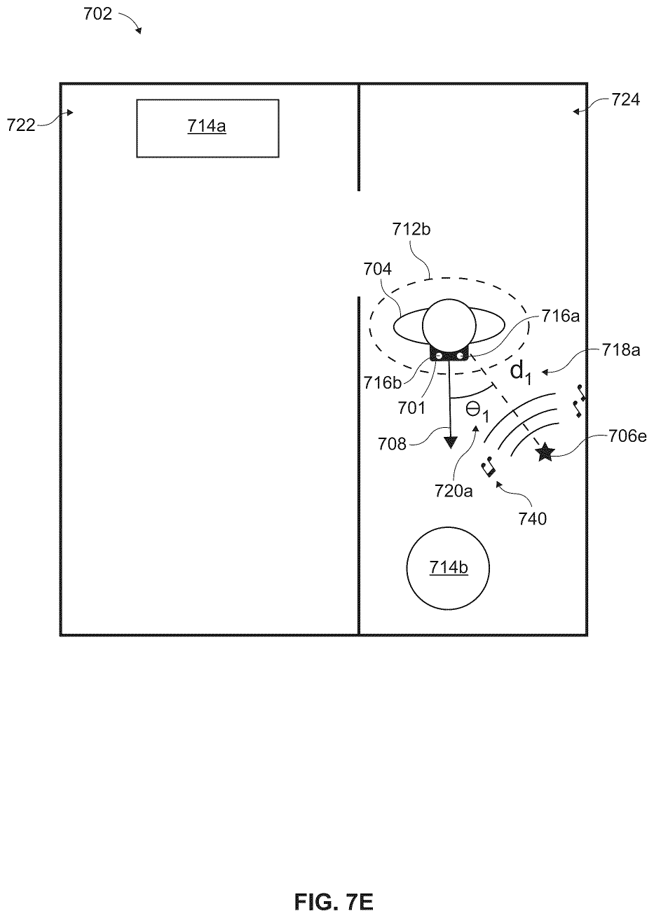

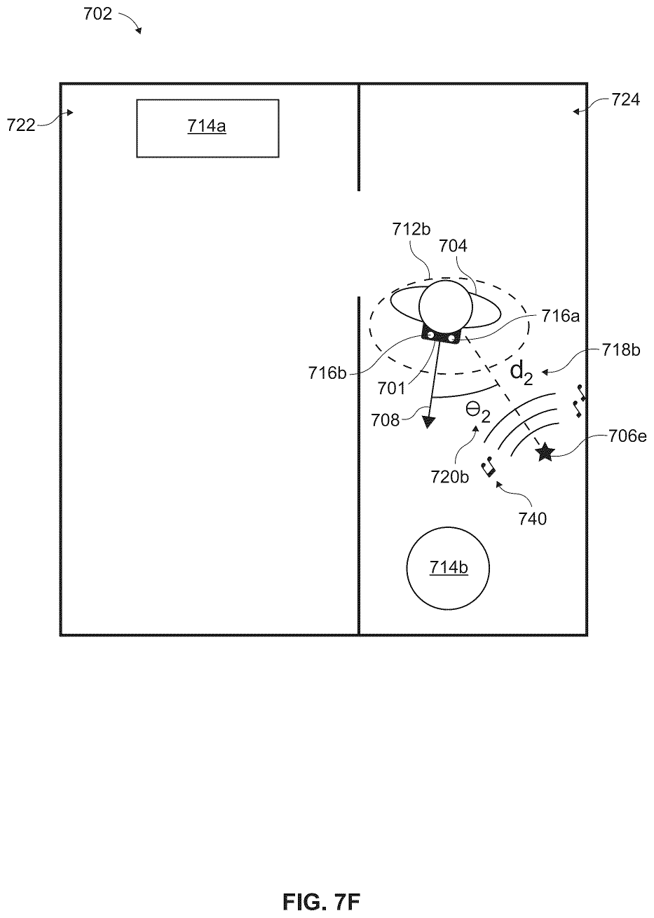

In some examples, electronic device 501 permits user 514 three degrees-of-freedom relative to a current simulated source location of audio content 540 (e.g., having one or more characteristics of the three degrees-of-freedom described below with reference to FIG. 7B). For example, the current simulated source location of audio content 540 is maintained in response to rotational movement of electronic device 501, including pitch, yaw, and roll of electronic device 501. As shown in FIG. 5F, in response to the change in the current pose of electronic device 501 from pose 530a to pose 530b, electronic device 501 maintains output of audio content 540 from simulated source location 520a. In some examples, in response to the change in pose of electronic device 501 from pose 530a to pose 530b, the output of audio content 540 changes to sound as though it is emanating from the same location in environment 500 (despite the change in the current viewpoint of user 514 relative to environment 500). For example, the change in output of audio content 540 includes a change in acoustic properties and/or volume distribution of the audio output (e.g., the output volume of audio output device 516b is less than the output volume of audio output device 516a because the change in pose of electronic device 501 causes audio output device 516b to be farther from simulated source location 520a than audio output device 516a). In some examples, maintaining output of audio content 540 from simulated source location 520a includes one or more characteristics of continuing to output the drum set source 302 from first simulated source location 324a and/or the guitar source 304 from second simulated source location 326a shown and described with reference to FIG. 3B. Optionally, in response to translational movement of electronic device 501 (e.g., walking around the environment as opposed to rotation of the head or torso), electronic device 501 changes the current simulated source location of audio content 540 such that fixed distance 526 is maintained between the current simulated source location of audio content 540 and user 514 (and/or electronic device 501) (e.g., as shown and described below with reference to FIGS. 7A-7E).

FIG. 5G illustrates electronic device 501 detecting an input corresponding to a request to perform a content recentering action according to examples of the disclosure. In some examples, electronic device 501 recenters content presented in environment 500 (e.g., virtual window 518 and/or audio content 540) relative to the current pose of electronic device 501 (e.g., and/or the current viewpoint of user 514) in response to user input. For example, user 514 changes their current viewpoint and/or location relative to environment 500 (e.g., through movement of user 514 relative to their physical environment while wearing electronic device 501), and desires for content (e.g., virtual window 518) to be presented within their current field of view. As shown in FIG. 5G, the input includes user 514 actuating hardware input device 510a using hand 508 (e.g., the input includes a tap input, tap-and-hold input, and/or a multi-tap input (e.g., a double-tap input)). In some examples, the input includes user 514 actuating and holding hardware input device 510a while moving relative to environment 500 (e.g., while changing the pose of electronic device 501) and releasing hardware input device 510a once user 514 reaches a preferred pose relative to environment 500. Alternatively, in some examples, the input includes selection of a virtual element presented in environment 500 (e.g., a selectable option from a menu presented in environment 500), detection of a gesture (e.g., an air gesture performed by a user of electronic device 501 that corresponds to a request to perform the content recentering action), a touch input (e.g., performed on a touch-sensitive surface and/or display electronic device 501 is in communication with) and/or an audio input (e.g., a verbal command).

FIG. 5H illustrates electronic device 501 recentering content in environment 500 in response to the input corresponding to the request to perform the content recentering action (shown in FIG. 5G) according to examples of the disclosure. As shown in FIG. 5H, electronic device 501 moves virtual window 518 to a location corresponding to a center of the current field of view of user 514. In some examples, in response to the input corresponding to the request to perform the content recentering action, electronic device 501 outputs audio content 540 from simulated source location 520b (e.g., electronic device 501 changes the output of audio content from simulated source location 520a to simulated source location 520b).

In some examples, in response to detecting the input corresponding to the request to perform the content recentering action, electronic device 501 presents virtual window 518 at a pre-set (e.g., default and/or stored in one or more system settings) spatial arrangement relative to the current viewpoint of user 514. Alternatively, in some examples, in response to detecting the input corresponding to the request to perform the content recentering action, electronic device 501 presents virtual window 518 at a user-defined (e.g., custom and/or stored in a user profile) spatial arrangement relative to the current viewpoint of user 514. For example, the pre-set and/or user-defined spatial arrangement includes a distance (e.g., optionally fixed distance 526) and/or orientation relative to the current pose of electronic device 501 (e.g., relative to the current viewpoint of user 514). In some examples, in response to detecting the input corresponding to the request to perform the content recentering action, electronic device 501 presents virtual window 518 at the same spatial arrangement relative to the current pose of electronic device 501 (and/or the current viewpoint of user 514) as when the audio streaming application was launched. For example, the location of virtual window 518 in FIG. 5H corresponds to the same spatial arrangement (e.g., location and/or orientation) relative to the current viewpoint of user 514 that virtual window 518 was presented at in FIG. 5B (e.g., when the audio streaming application was launched).

In some examples, in response to the input corresponding to the request to perform the content recentering action, electronic device 501 re-establishes a previous spatial arrangement of virtual window 518 (e.g., distance and/or orientation relative to the current viewpoint of user 514) that was set by user 514. For example, as shown in FIGS. 5D-5E, electronic device 501 moves virtual window 518 to a position (e.g., location and/or orientation) in environment 500 in response to user input. Optionally, in response to the input corresponding to the request to perform the content recentering action, electronic device 501 presents virtual window 518 at the same distance and/or orientation relative to the current viewpoint of user 514 shown in FIG. 5E (e.g., at the same distance and/or orientation relative to the viewpoint of the user 514 prior to the change in pose of electronic device 501 from pose 530a to 530b shown in FIG. 5F).

In some examples, in response to the input corresponding to the request to perform the content recentering action, electronic device 501 outputs audio content 540 from simulated source location 520b to correspond to the recentered position of virtual window 518 in environment 500. In some examples, in response to the input corresponding to the request to perform the content recentering action, electronic device 501 identifies simulated source location 520b independent from the recentered position of virtual window 518 in environment 500.

In some examples, in response to the input corresponding to the request to perform the content recentering action, electronic device 501 outputs audio content 540 from a respective simulated source location that includes a same spatial relationship with the current pose of electronic device 501 (e.g., relative to the current viewpoint of user 514) as when output of audio content 540 was initiated. For example, as shown in FIG. 5H, simulated source location 520b is the same fixed distance 526 from electronic device 501 (and the location corresponding to user 514) in environment 500 as simulated source location 520a (shown in FIGS. 5C-5G). For example, as shown in FIG. 5H, the spatial relationship (e.g., location and/or orientation) between simulated source location 520b and pose 530b of electronic device 501 is the same as the spatial relationship between simulated source location 520a and pose 530a of electronic device 501 (e.g., as shown in FIG. 5C when output of audio content 540 was initiated). Thus, in some examples, electronic device 501 outputs audio content 540 (using audio output devices 516a-516b) in the same manner (e.g., with the same volume distribution between audio output devices 516a-516b and/or acoustic properties) in FIG. 5H as in FIGS. 5C-5E (because the spatial relationship between pose 530a of electronic device 501 and simulated source location 520a is the same as the spatial relationship between pose 530b of electronic device 501 and simulated source location 520b). Outputting audio content 540 with the same spatial relationship with electronic device 501 in response to a content recentering action conserves computing resources by not requiring user 514 to perform additional inputs to set (e.g., manually) the output location of audio content 540 after requesting to recenter content in environment 500.

In some examples, in response to the input corresponding to the request to perform the content recentering action, electronic device 501 outputs audio content 540 from a respective simulated source location that includes a pre-set and/or user-defined spatial arrangement relative to the current pose of electronic device 501 (e.g., that is optionally different from the pre-set and/or user-defined spatial arrangement of virtual window 518 in environment 500 relative to the current pose of electronic device 501). For example, the respective simulated source location that electronic device 501 outputs audio content 540 from in response to a request to perform the content recentering action corresponds to a spatial arrangement stored in system settings and/or a user profile. In some examples, in response to the input corresponding to the request to perform the content recentering action, electronic device 501 outputs audio content 540 from the same spatial arrangement relative to the current viewpoint of user 514 that audio content 540 was output from upon initiating output of audio content 540 (e.g., the spatial relationship between simulated source location 520b and electronic device 501 at pose 530b (shown in FIG. 5H) is the same as the spatial relationship between simulated source location 520a and electronic device 501 at pose 520a (shown in FIG. 5C)). Outputting audio content 540 from a pre-set and/or user-defined spatial arrangement in response to a content recentering action conserves computing resources by not requiring user 514 to perform additional inputs to set (e.g., manually) the output location of audio content 540 after requesting to recenter content in environment 500.

In some examples, electronic device 501 stores information associated with simulated source location 520b in a memory (e.g., having one or more characteristics of memory 220 described with reference to FIG. 2). For example, in accordance with electronic device 501 ceasing to output audio content 540 in environment 500 (e.g., in response to user input, such as in response to selection of playback affordance 528), electronic device 501 stores simulated source location 520b such that, upon re-initiating output of audio content 540 in environment 500, electronic device 501 outputs audio content 540 from simulated source location 520b and/or from a respective simulated source location that includes the same spatial relationship with the current pose of electronic device 501 as the spatial relationship between simulated source location 520b and pose 530b of electronic device 501. For example, after pausing output of audio content 540 (e.g., in response to detecting selection of playback affordance 528), electronic device 501 detects an input corresponding to a request to resume output of audio content 540 (e.g., as shown and described with reference to FIG. 5B). In response to detecting the input corresponding to the request to output audio content 540, electronic device 501 optionally outputs audio content 540 from simulated source location 520b in environment 500. Alternatively, in response to detecting the input corresponding to the request to output audio content 540, and in accordance with a determination that the current pose of electronic device 501 is different from pose 530b, electronic device 501 optionally outputs audio content 540 from a respective simulated source location that has the same spatial relationship with the current pose of electronic device 501 as the spatial relationship between simulated source location 520b and pose 530b of electronic device 501.

In another example, after ceasing user interaction with the audio streaming application (e.g., by ending the current user session with the audio streaming application (e.g., by ceasing to present virtual window 518 and/or ceasing to output audio content 540)), electronic device 501 detects an input corresponding to a request to launch the audio streaming application (e.g., to start a new user session with the audio streaming application, such as by selection of icon 534 in home user interface 502 shown in FIG. 5A). In response to detecting the input corresponding to the request to launch the audio streaming application, electronic device 501 optionally outputs audio content 540 from simulated source location 520b and/or from a simulated source location that has the same spatial relationship with the current pose of electronic device 501 as the spatial relationship between simulated source location 520b and pose 530b of electronic device 501. Alternatively, in response to detecting the input corresponding to the request to launch the audio streaming application, electronic device 501 presents virtual window 518 in environment 500, and in response to a second input corresponding to a request to output audio content 540 (e.g., by selection of playback affordance 528 as shown and described with reference to FIG. 5B), electronic device 501 outputs audio content 540 from simulated source location 520b and/or from a respective simulated source location that has the same spatial relationship with the current pose of electronic device 501 as the spatial relationship between simulated source location 520b and pose 530b of electronic device 501.

Optionally, in response to an input corresponding to a request to output audio content 540 in environment 500, electronic device 501 determines the respective simulated source location to output audio content 540 independent from a previous content recentering action. For example, as shown and described with reference to FIGS. 5B-5C, electronic device 501 determines the respective simulated source location of audio content 540 from a direction indicated by one or more input devices of electronic device 501 (e.g., when the input corresponding to the request to output audio content 540 in environment 500 is performed).

Optionally, in response to an input corresponding to a request to output audio content 540 in environment 500, in accordance with a determination that a previous content recentering action was performed by electronic device 501 (e.g., within the current user session with audio streaming application), electronic device 501 outputs audio content 540 from a respective simulated source location that is based on the previous content recentering action (e.g., as shown and described with reference to FIGS. 5G-5H). In some examples, in response to the input corresponding to the request to output audio content 540 in environment 500, in accordance with a determination that a previous content recentering was not performed by electronic device 501 (e.g., within the current user session with audio streaming application), electronic device 501 outputs audio content 540 from a respective simulated source location that is based on a direction indicated by the one or more input devices of electronic device 501 (e.g., corresponding to gaze direction and/or a current pose of electronic device 501, as shown and described with reference to FIGS. 5B-5C).

In some examples, electronic device 501 performs a content recentering action in response to detecting a change in the current pose of electronic device 501 that satisfies one or more criteria. For example, the content recentering action includes recentering of virtual content presented in environment 500 (e.g., virtual window 518) and/or recentering audio content (e.g., audio content 540). For example, electronic device 501 performs the content recentering action automatically (e.g., without detecting the user input corresponding to the request to perform the content recentering action, as shown in FIG. 5G). In some examples, the one or more criteria includes a requirement that the change in the current pose of electronic device 501 exceeds a threshold amount of change. For example, the threshold amount of change has one or more characteristics of the threshold amount of change of the pose of the audio output device shown and described with reference to FIGS. 3C-3D. Additionally, or alternatively, in some examples, the one or more criteria includes a requirement that electronic device 501 remains at or near the changed pose for a threshold time duration. For example, the threshold time duration has one or more characteristics of the threshold time duration described with reference to FIGS. 3C-3D. For example, electronic device 501 performs the content recentering action (e.g., recentering virtual window 518 and/or the current simulated source location of audio content 540 without the user input shown and described with reference to FIG. 5G) in accordance with a determination that the change in the current pose of electronic device 501 from pose 530a to pose 530b exceeds the threshold amount of change and in accordance with a determination that electronic device 501 has remained at or near pose 530b for more than the threshold time duration.

In some examples, performing the content recentering action includes transitioning from outputting audio content 540 from simulated source location 520a to simulated source location 520b. For example, electronic device 501 fades out (e.g., reduces the volume of) the output of audio content 540 from simulated source location 520a and, optionally serially or concurrently, fades in (e.g., increases the volume of) the output of audio content 540 from simulated source location 520b (e.g., electronic device 501 crossfades between outputting audio content 540 from simulated source location 520a and outputting audio content 540 from simulated source location 520b). Additionally, or alternatively, in some examples, electronic device 501 simulated auditory movement of audio content 540 along a path (e.g., a curved path, such as arc 330 shown and described with reference to FIG. 3D) from simulated source location 520a to simulated source location 520b. In some examples, transitioning from outputting audio content 540 from simulated source location 520a to simulated source location 520b has one or more characteristics of transitioning the output of the audio sources from the initial simulated source location to the new simulated source locations as described with reference to FIG. 3D.

In some examples, electronic device 501 transitions the output of audio content 540 in different manners based on the type of input that triggers electronic device 501 to perform the content recentering action. For example, in accordance with the input corresponding to a request to perform the content recentering action (as shown and described with reference to FIG. 5G), electronic device 501 transitions the output of audio content 540 over a first time duration (e.g., over 0.01, 0.05, 0.1, 0.5, 1, 3, 5, 10, or 20 seconds). For example, when the content recentering action is performed by electronic device 501 in response to actuation of a hardware input device (e.g., hardware input devices 510a or 510b), electronic device 501 transitions the output of audio content 540 from simulated source location 520a to simulated source location 520b instantaneously (or within 0.01, 0.02, 0.05, 0.1, 0.2, 0.5, 1, 2, or 5 seconds of detecting the actuation of the hardware input device). Additionally, or alternatively, for example, in accordance with the input corresponding to a change in the current pose of electronic device 501 that exceeds a threshold amount (e.g., as described above, and shown with reference to electronic device 301 in FIG. 3D), electronic device 501 transitions the output of audio content 540 over a second time duration that is greater than the first time duration. For example, when the content recentering action is performed (e.g., automatically) in response to detecting a change in the current pose of electronic device 501 that exceeds a threshold amount, electronic device 501 gradually transitions the output of audio content 540 from simulated source location 520a to simulated source location 520b (e.g., by simulating auditory movement of audio content 540 over an extended period of time, such as over 1, 2, 3, 5, 10, or 20 seconds).

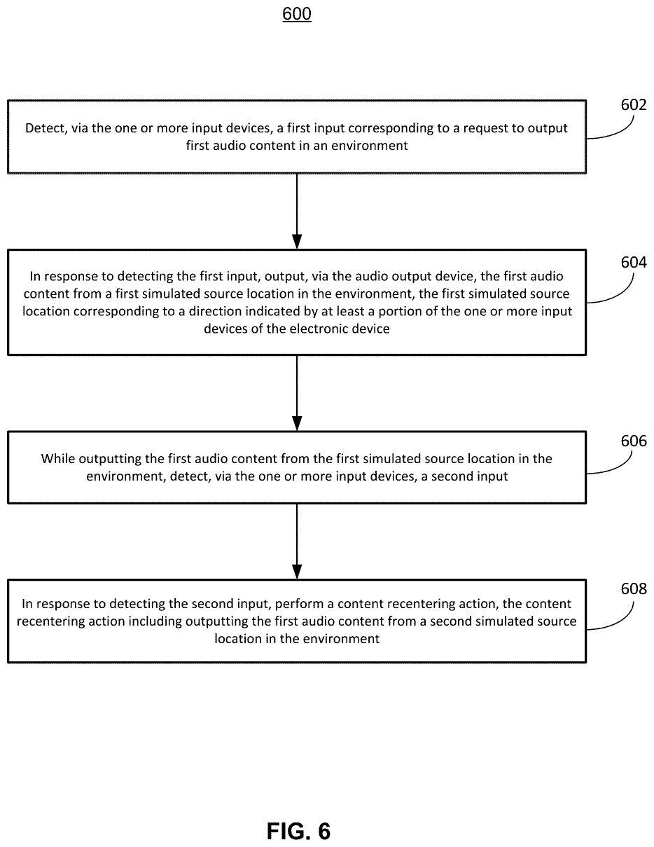

FIG. 6 illustrates a flow diagram for method 600 of determining simulated source locations from which to output audio content in an environment according to examples of the disclosure. In some examples, method 600 begins at an electronic device in communication with (e.g., including or communicating signals with) an audio output device. In some examples, the electronic device is optionally a head-mounted device similar to or corresponding to electronic device 201 of FIG. 2, and the audio output device corresponds to one or more speakers included in the electronic device, such as speakers 216 of FIG. 2. In some examples, the electronic device is another type of device, such as a phone, tablet, laptop computer, audio transceiver, or television, and the audio output device includes headphones or earbuds in communication with the electronic device.

At block 602, the electronic device detects, via the one or more input devices, a first input corresponding to a request to output first audio content in an environment. For example, as shown in FIG. 5B, electronic device 501 detects an input corresponding to a request to output audio content in environment 500. For example, the first input includes selection of a virtual element presented in the environment, such as selection of playback affordance 528 presented within virtual window 518 in FIG. 5B. In some examples, the first input includes attention of a user of the electronic device directed to the virtual element (e.g., gaze 524 directed to playback affordance 528 in FIG. 5B) and a hand gesture (e.g., the air pinch performed with hand 508 in FIG. 5B). In some examples, the first input corresponds to a touch input on a touch-sensitive surface in communication with the electronic device (e.g., a trackpad or a touch screen). In some examples, the first input corresponds to an input provided through a keyboard and/or mouse in communication with the electronic device. In some examples, the first input corresponds to an audio input (e.g., a verbal command) provided by the user (e.g., detected by microphone 213 described with reference to FIG. 2).

At block 604, in response to detecting the first input, the electronic device outputs, via the audio output device (e.g., audio output devices 516a-516b), the first audio content (e.g., audio content 540) from a first simulated source location (e.g., simulated source location 520a) in the environment. In some examples, the first simulated source location corresponds to a direction indicated by at least a portion of the one or more input devices of the electronic device. For example, in response to the user input shown in FIG. 5B, electronic device 501 outputs audio content 540 from simulated source location 520a in environment 500. In some examples, simulated source location 520a corresponds to a direction indicated by one or more input devices of electronic device 501 (e.g., indicated by image sensor(s) 206, orientation sensor(s) 210, and/or eye tracking sensor(s) 212). For example, simulated source location 520a corresponds to a direction of attention (e.g., gaze 524 shown in FIG. 5B) of user 514 that is detected by electronic device 501 (e.g., by eye tracking sensor(s) 212 described with reference to FIG. 2) when the first input (e.g., the input shown and described with reference to FIG. 5B) is performed. In some examples, simulated source location 520a corresponds to a pose of electronic device 501 relative to environment 500 when the first input is detected by electronic device 501 (e.g., simulated source location 520a corresponds to a forward direction of electronic device 501 at pose 530a shown in FIG. 5C). For example, simulated source location 520a is centered relative to a forward direction of electronic device 501 at pose 530a.

At block 606, while outputting the first audio content from the first simulated source location in the environment, the electronic device detects, via the one or more input devices, a second input. For example, the second input corresponds to a request to perform a recentering action in the environment, as shown and described with reference to FIG. 5G. For example, as shown in FIG. 5G, the input includes actuation of a hardware input device 510a of electronic device 501. Alternatively or additionally, in some examples, the second input corresponds to a change in pose of the electronic device that exceeds a threshold amount of change. For example, as shown in FIGS. 3C-3D, electronic device 301 detects a change in the pose of the audio output device (e.g., and electronic device 301) from first pose 322a shown in FIG. 3A to second pose 322b shown in FIG. 3B or third pose 322c shown in FIGS. 3C and 3D (e.g., by detecting a change in the location and/or orientation of electronic device 301 relative to first pose 322a). Optionally, detecting the second input includes detecting that the electronic device has remained at the changed pose for over a time duration (e.g., over 0.1, 0.5, 1, 3, 5, 10, or 20 seconds), as shown and described with reference to FIG. 3D.

At block 608, in response to detecting the second input, the electronic device performs a content recentering action, the content recentering action including outputting the first audio content from a second simulated source location (e.g., simulated source location 520b) in the environment. For example, in response to the input detected by electronic device 501 in FIG. 5G, electronic device 501 changes (e.g., transitions) the output of audio content 540 from simulated source location 520a to simulated source location 520b. For example, the second simulated source location (e.g., simulated source location 520b) has a spatial relationship with the current pose of the electronic device 501 (e.g., pose 530b) that is the same as the spatial relationship between the first simulated source location (e.g., simulated source location 520a) and the pose of the electronic device 501 when output of the audio content (e.g., audio content 540) was initiated. In some examples, the second simulated source location is centered relative to a current viewpoint of the user of the electronic device. For example, as shown in FIG. 5H, simulated source location 520b is centered relative to pose 530b of electronic device 501 (e.g., audio content 540 is distributed equally (e.g., at an equal volume) between audio output device 516a and audio output device 516b). The content recentering action optionally includes moving one or more virtual objects (e.g., virtual window 518) in the environment. For example, as shown in FIGS. 5G-5H, virtual window 518 is recentered relative to pose 530b of electronic device 501 (e.g., relative to the current viewpoint of user 514).

FIGS. 7A-7F illustrate an electronic device updating a simulated source location of audio content in an environment in response to a change in pose of the electronic device according to examples of the disclosure.

While outputting audio content, via one or more audio output devices of an electronic device, from a simulated source location in an environment (e.g., having one or more characteristics of the environments described above), movement of a user of the electronic device can cause the audio output to have one or more undesirable acoustic properties. For example, if the audio content is output such that it sounds, to the user, as though it is stationary when the user moves within the environment, movement of the user away from the simulated source location can cause the audio content to sound as though it is undesirably far away. Further, movement of the user that intersects the simulated source location in the environment can cause the audio content to sound as through it is undesirably close to the user, or cause the audio content to have other undesirable acoustic properties (e.g., that sound as though the user is walking through the audio content). Yet, while moving in the environment, the user may desire for the electronic device to maintain output of the audio content with some type of spatial effect (e.g., by changing one or more acoustic properties of the output of the audio content in response to head movement).

In some examples, an electronic device changes a mode of output of audio content in response to a change in pose of the electronic device that exceeds a threshold amount. For example, in response to a change in pose of the electronic device that exceeds the threshold amount (e.g., corresponding to walking about the three-dimensional environment rather than head rotation while remaining in place within the three-dimensional environment), the electronic device outputs the audio content with a fixed spatial relationship relative to a first portion of the user of the electronic device and/or relative to a first portion of the electronic device instead of from the fixed spatially location in the three-dimensional environment. For example, the fixed spatial relationship includes a fixed distance relative to the first portion of the user. For example, the first portion of the user corresponds to the torso of the user (e.g., the user's chest, waist, abdomen, and/or other portions of the user's body apart from the head). For example, the fixed spatial relationship includes a fixed distance relative to the first portion of the electronic device. For example, the first portion of the electronic device corresponds to a front portion of the electronic device (e.g., corresponding to a forward direction). In some examples, the electronic device maintains output of the audio content with the fixed spatial relationship to the first portion of the user and/or electronic device during the continued movement of the pose of the electronic device. Further, in some examples, the electronic device can change one or more acoustic properties of the output of the audio content in response to a change in orientation of a second portion (e.g., head), different from the first portion, of the user to maintain output of the audio content with a spatial effect during the movement of the user in the environment. Changing a mode of output of spatial audio content in response to a change in pose of an electronic device conserves computing resources associated with additional inputs to correct undesired acoustic characteristics of audio output (e.g., user inputs to move the simulated source location of audio content in an environment).

FIGS. 7A-7F illustrate an overhead view of a user 704 wearing an electronic device 701 in an environment 702. In some examples, electronic device 701 has one or more characteristics of electronic device 301 and/or 501 described above. In some examples, environment 702 has one or more characteristics of environment 500 shown and described with reference to FIGS. 5A-5H. For example, environment 702 is an XR environment that is visible to user 704 through one or more displays of electronic device 701. Electronic device 701 optionally presents virtual content (e.g., a virtual window, such as virtual window 518 illustrated in FIG. 5B) via the one or more displays in environment 702 from the viewpoint of user 704. As shown in FIG. 7A, electronic device 701 includes audio output devices 716a-716b. In some examples, audio output devices 716a-716b have one or more characteristics of audio output devices 316a-316b shown and described with reference to FIGS. 3A-3D and/or audio output devices 516a-516b shown and described with reference to FIGS. 5A-5H.

In FIGS. 7A-7F, environment 702 includes a first region 722 and a second region 724. In some examples, first region 722 corresponds to a first room in a physical environment of user 704, and second region 724 corresponds to a second room (e.g., user 704 is shown in an indoor environment). Further, a first real-world object 714a is shown in first region 722, and a second real-world object 714b is shown in second region 724. As shown in FIGS. 7B-7E, user 704 can move between first region 722 and second region 724 while electronic device 701 maintains output of audio content 740, via audio output devices 716a-716b, in environment 700.

In FIG. 7A, audio content 740 is output from a simulated source location 706a in environment 700. In some examples, audio content 740 has one or more characteristics of audio content 540 shown and described with reference to FIGS. 5A-5H. In some examples, electronic device 701 determines to output audio content 740 from simulated source location 706a based on a direction indicated by one or more input devices of electronic device 701 while an input corresponding to a request to output audio content 740 is detected (e.g., as shown and described with reference to audio content 540 in FIGS. 5B-5C). In some examples, electronic device 701 determines to output audio content 740 from simulated source location 706a in response to an input corresponding to a request to perform a recentering action (e.g., as shown and described with reference to audio content 540 in FIGS. 5G-5H). In some examples, simulated source location 706a is user-defined (e.g., a preferred simulated source location that is stored in a user profile (e.g., that electronic device 701 automatically outputs audio content 740 from), or a location that user 704 moved the output of audio content 740 to (e.g., manually) through user-input).

As shown in FIG. 7A, a threshold 712a is illustrated (as a dashed oval surrounding user 704). In some examples, threshold 712a corresponds to a threshold amount of change in pose (e.g., location) of electronic device 701 (e.g., caused by movement of user 704 in environment 702). For example, threshold 712a has one or more characteristics of the threshold amount of change described with reference to FIGS. 3A-3D. In some examples, threshold 712a corresponds to a threshold distance (e.g., 0.01, 0.1, 0.2, 0.5, 1, 2, or 5 meters) from an initial pose of electronic device 701. For example, threshold 712a is set after the pose of electronic device 701 changes by less than a threshold amount (e.g., 0.01, 0.2, 0.2, 0.5, 1, 2, or 5 meters) over a threshold amount of time (0.1, 0.2, 0.5, 1, 2, 5, or 10 seconds). Optionally, the threshold amount of change in pose of electronic device 701 includes a threshold orientation (e.g., 5, 15, 30, 45, or 90 degrees of rotation), a threshold velocity (e.g., 0.1, 0.2, 0.5, 1, 2, or 5 m/s) and/or a threshold duration of movement (e.g., 0.05, 0.1, 0.2, 0.5, 1, 2, or 5 seconds). Optionally, the threshold amount of change in pose includes other physical characteristics relative to the physical environment of user 704, such as a distance between a first location and a second location (e.g., within first region 722 and/or second region 724), or contextual metrics (e.g., as described with reference to method 400).

It should be appreciated that the schematic representations of the current simulated source location (e.g., simulated source locations 706a-706e), distance 718a (or distance 718b), orientation 720a (or orientation 720b) and audio content 740 shown in FIGS. 7A-7F are illustrated for reference, and optionally do not correspond to virtual elements that are presented by electronic device 701 (via one or more displays) in environment 700.

In some examples, simulated source location 706a has a spatial relationship relative to a first portion 708 of user 704 (e.g., first portion 708 is represented by an arrow extending from user 704 (e.g., corresponding to a forward direction and/or orientation of the first portion in environment 702)). For example, first portion 708 corresponds to a torso of user 704 (e.g., as described above). As shown in FIG. 7A, the spatial relationship includes a distance 718a (shown as d1) relative to first portion 708 and orientation 720a (shown as theta 1) relative to first portion 708.

In some examples, in FIG. 7A, electronic device 701 outputs audio content 740 in a first mode. In some examples, outputting audio content 740 in the first mode includes maintaining output of audio content 740 from simulated source location 706a in response to a change in pose of electronic device 701 that is less than threshold 712a (e.g., such that user 704 may perceive audio content 740 as emanating from a stationary location in environment 702). For example, in response to a change in pose of electronic device 701 that is less than threshold 712a, the spatial relationship between simulated source location 706a and first portion 708 of user 704 changes (e.g., the distance and/or orientation of simulated source location 706 changes relative to first portion 708). For example, in response to the change in pose of electronic device 701 (e.g., that causes a change in spatial relationship between simulated source location 706a and first portion 708), audio output devices 716a-716b change one or more acoustic properties of audio content 740 (e.g., to simulate movement of user 704 relative to the stationary location of audio content 740 in environment 702). In some examples, when movement of electronic device 701 and/or user 704 is within threshold 712a, audio content 740 is output, via audio output devices 716a-716b, such that user 704 is permitted six degrees-of-freedom relative to simulated source location 706a (e.g., as described with reference to FIG. 5C). Outputting audio content 740 in the first mode enables user 704 to rotate (e.g., their head and/or body) to different positions in environment 702 to experience spatial audio without changing the location of output (simulated source location 706a) of audio content 740, which improves user experience and user-device interaction (e.g., by allowing user 704 to make minor movements without affecting the output of audio content 740) and conserves computing resources (e.g., associated with moving the simulated source location of audio content 740 in response to minor movement of user 704).

FIG. 7B illustrates electronic device 701 outputting audio content 740 in a second mode in response to detecting a change in pose of electronic device 701 that exceeds threshold 712a (e.g., walking forward more than a threshold amount). In some examples, the change in pose of electronic device 701 is caused by movement of user 704 relative to environment 702. For example, in FIG. 7B, user 704 (and electronic device 701) moves from an initial location within the ellipse representing threshold 712a (shown in FIG. 7A) to a location outside of threshold 712a. In some examples, in response to the change in pose of electronic device 701 that exceeds threshold 712a, electronic device 701 outputs audio content 740 from a respective simulated source location that includes a fixed spatial relationship relative to first portion 708 of user 704 (e.g., relative to the torso of user 704). For example, in the second mode of output, electronic device 701 maintains the fixed spatial relationship between a current simulated source location of audio content 740 and first portion 708 during continued movement of user 704 (and of the pose of electronic device 701) in environment 702.

In FIG. 7B, electronic device 701 outputs audio content 740 from a simulated source location 706b. For example, simulated source location 706b includes the fixed spatial relationship relative to first portion 708. In some examples, as shown in FIG. 7B, the fixed spatial relationship includes distance 718a and orientation 720a relative to first portion 708. For example, when outputting audio content 740 in the second mode, electronic device 701 outputs audio content 740 from a respective simulated source location that includes distance 718a and orientation 720a relative to first portion 708 of user 704. Further, in some examples, in response to continued movement of user 704 in environment 702 while audio content 740 is output in the second mode, electronic device 701 outputs audio content 740 maintains distance 718a and orientation 720a between the current simulated source location of audio content 740 and first portion 708 of user 704.

In some examples, electronic device 701 determines the fixed spatial relationship between the current simulated source location of audio content 740 and first portion 708 based on the spatial relationship a respective simulated source location of audio content 740 had relative to first portion 708 when the change in pose of electronic device 701 (e.g., the movement of user 704) was initiated. For example, as shown in FIG. 7B, the fixed spatial relationship between simulated source location 706b and first portion 708 corresponds to the spatial relationship between simulated source location 706a and first portion 708 shown in FIG. 7A prior to user 704 moving in environment 702 (e.g., simulated source location 706a shown in FIG. 7A has the same distance 718a and orientation 720a relative to first portion 708 as simulated source location 706b shown in FIG. 7B).

Alternatively, in some examples, electronic device 701 determines the fixed spatial relationship between the current simulated source location of audio content 740 and first portion 708 based on the spatial relationship first portion 708 has to a respective simulated source location of audio content 740 (e.g., simulated source location 706a shown in FIG. 7A) when the change in pose of electronic device 701 exceeded threshold 712a (e.g., the spatial relationship between simulated source location 706a (shown in FIG. 7A) and first portion 708 changes prior to user 704 moving to a location in environment 702 that is outside threshold 712a). For example, the fixed distance and/or orientation between simulated source location 706b and first portion 708 (e.g., when audio content 740 is output in the second mode) is optionally different from the distance and/or orientation between simulated source location 706a and first portion 708 (e.g., when audio content 740 is output in the first mode (e.g., prior to user 704 initiating the movement that caused a change in pose of electronic device 701 that exceeded threshold 712a)).

In some examples, the fixed spatial relationship between the current simulated source location of audio content 740 and first portion 708 corresponds to a pre-set (e.g., default, as defined by system settings of electronic device 701) and/or user-defined (e.g., stored in a user profile of user 704) spatial relationship. For example, in response to detecting a change in pose of electronic device 701 that exceeds threshold 712a, electronic device 701 outputs audio content 740 from a respective simulated source location that includes a user-defined distance and/or orientation relative to first portion 708 (e.g., distance 718a and orientation 720a correspond to a fixed spatial relationship relative to first portion 708 that is preferred by user 704 when audio content 740 is output in the second mode).

In some examples, electronic device 701 maintains the fixed spatial relationship between audio content 740 and first portion 708 when audio content 740 is output in the second mode (e.g., a current simulated source location of audio content 740 is locked at distance 718a and/or orientation 720a relative to the torso of user 704 during continued movement of user 704 in environment 702). For example, user 704 is permitted three degrees-of-freedom of head movement relative to a current simulated source location of audio content 740 (e.g., relative to simulated source location 706b shown in FIG. 7B). For example, electronic device 701 maintains the current simulated source location of audio content 740 in response to a change in orientation of the current pose of electronic device 701 that does not include a change in orientation of first portion 708 (e.g., in accordance with a determination that a current pose of first portion 708 is maintained, electronic device 701 maintains output of audio content 740 from a current simulated source location in environment 702 in response to rotational movement of electronic device 701, including pitch, yaw, and roll of electronic device 701 relative to the current simulated source location). In some examples, in the second mode, electronic device 701 changes a current simulated source location of audio content 740 in response to translational and/or rotational movement of the current pose of electronic device 701 that includes translational and/or rotational movement of first portion 708 (e.g., in accordance with a determination that the current pose of first portion 708 is changed relative to environment 702, electronic device 701 changes the current simulated source location of audio content 740 to maintain the fixed spatial relationship between the current simulated source location of audio content 740 and first portion 708). Maintaining a fixed spatial relationship between audio content 740 and first portion 708 in response to movement (e.g., change in pose of electronic device 701) that exceeds a threshold amount provides a continuous user experience (e.g., by continuing to spatially output audio content 740 in environment 700 during user movement) and conserves computing resources associated with corrective inputs (e.g., associated with relocating the output of audio content 740 in environment 700 during and/or after movement (e.g., to avoid undesirable acoustic properties)).

FIG. 7C illustrates electronic device 701 continuing to output audio content 740 in the second mode in response to continued movement of user 704 in environment 702 according to examples of the disclosure. For example, user 704 continues their movement relative to environment 702 from their initial position shown in FIG. 7A (e.g., causing a continued change in pose of electronic device 701 relative to environment 702). As shown in FIG. 7C, electronic device 701 maintains output of audio content 740 from a current simulated source location (e.g., simulated source location 706c) that includes distance 718 and orientation 720a relative to first portion 708 (e.g., simulated source location 706c includes the same spatial relationship (e.g., the fixed spatial relationship) relative to the current pose of first portion 708 shown in FIG. 7C as simulated source location 706b relative to the current pose of first portion 708 shown in FIG. 7B).

In FIG. 7C, electronic device 701 includes a different orientation relative to the current simulated source location (simulated source location 706c) of audio content 740 than shown in FIG. 7B. For example, during the movement of user 704 in environment 702, user 704 rotates their head (e.g., to their right), causing a change in orientation of the current pose of electronic device 701. Further, the change in orientation of the current pose of electronic device 701 does not include a change in orientation of the current pose of first portion 708. Accordingly, the current pose of electronic device 701 (e.g., illustrated by a dashed arrow 710 in FIG. 7C) includes a different orientation than first portion 708 in environment 702. In response to the change in orientation of electronic device 701 (e.g., to an orientation that is different from first portion 708), electronic device 701 maintains output of audio content 740 from a current simulated source location that includes the fixed spatial relationship to first portion 708 (e.g., causing a change in the spatial relationship between the current simulated source location of audio content 740 and the current pose of electronic device 701). In some examples, electronic device 701 outputs audio content 740 (e.g., using audio output devices 716a-716b) in FIG. 7C with acoustic properties and/or volume distribution that is different from the output of audio content 740 in FIG. 7B (because the spatial relationship between the current pose electronic device 701 and the current simulated source location of audio content 740 is different in FIG. 7C compared to FIG. 7B). For example, audio output devices 716a-716b output audio content 740 with less volume in FIG. 7C than in FIG. 7B because audio output devices 716a-716b are farther from the current simulated source location of audio content 740 in FIG. 7C compared to in FIG. 7B (e.g., because, in FIG. 7C, the head of user 704 is turned away from simulated source location 706c). Permitting a change in pose of electronic device 501 (e.g., through rotational movement) without changing a fixed spatial relationship between a current simulated source location of audio content 740 and first portion 708 provides user 514 discretion to view other portions of environment 500 during movement while maintaining the spatial audio effect of the output of audio content 740 (which improves user experience and user-device interaction by preventing unintended changes in the output of audio content 740, and limits battery consumption by limiting the need for corrective user inputs).

FIG. 7D illustrates electronic device 701 continuing to output audio content 740 in the second mode in response to continued movement of user 704 in environment 702 (e.g., causing continued change in pose of electronic device 701) according to examples of the disclosure. For example, the movement of user 704 in FIG. 7D is continued from the movement of user 704 shown in FIGS. 7B-7C (e.g., from the position of user 704 shown in FIG. 7A). The movement of user 704 in FIG. 7D includes a change in orientation both the current pose of electronic device 701 and the current pose of first portion 708 (e.g., user 704 turns their body, including their torso and head, to their right). For example, user 704 is moving toward the entrance of second region 724 of environment 702, which requires the user 704 to turn their body. In some examples, in response to the change in orientation of first portion 708, electronic device 701 changes the current simulated source location of audio content 740 to maintain the fixed spatial relationship between the current simulated source location of audio content 740 and the current pose of first portion 708. For example, as shown in FIG. 7D, audio content 740 is output from a simulated source location 706d that includes the distance 718a and orientation 720a relative to first portion 708.

In some examples, as shown in FIG. 7D, the current pose of electronic device 701 includes the same orientation as the current pose of first portion 708. For example, the spatial relationship between the current pose of electronic device 701 relative to simulated source location 706d in FIG. 7D is different from the spatial relationship between the current pose of electronic device 701 (e.g., represented by arrow 710) and simulated source location 706c in FIG. 7C. For example, in FIG. 7D, electronic device 701 outputs audio content 740 with different acoustic properties and/or volume distribution than in FIG. 7C (e.g., audio content 740 is output by audio output devices 716a-716b with greater volume in FIG. 7D than in FIG. 7C because audio output devices 716-716b are closer to the current simulated source location of audio content 740 in FIG. 7D than in FIG. 7C).

FIG. 7E illustrates electronic device 701 outputting audio content 740 in the first mode in accordance with a determination that one or more criteria are satisfied according to examples of the disclosure. For example, the one or more criteria includes a criterion that electronic device 701 has remained at or near a pose relative to environment 702 for a threshold time duration (e.g., as described with reference to FIG. 3D). For example, the criterion is satisfied when the current pose (e.g., location and/or orientation) of electronic device 701 has changed by less than a threshold amount (e.g., less than 0.05, 0.1, 0.2, 0.5, 1, 2, or 5 meters, or less than 0.1, 0.2, 0.5, 1, 2, 5 or 10 degrees) within 0.1, 0.2, 0.5, 1, 2, 5 or 10 seconds. In some examples, in accordance with the determination that the one or more criteria are satisfied, electronic device 701 resets the threshold amount of change in pose that is required for outputting audio content 740 in the second mode. For example, as shown in FIG. 7E, a new threshold 712b (e.g., a schematic representation of the threshold amount of change in pose) is shown surrounding a current location of user 704 and electronic device 701 (e.g., because the one or more criteria were satisfied). For example, threshold 712b has one or more characteristics of threshold 712a described above (e.g., threshold 712b optionally corresponds to the same amount of change in pose of electronic device 701 as threshold 712a). In some examples, in FIG. 7E, the one or more criteria are satisfied after user 704 has moved to second region 724 and ceased their movement relative to environment 702. Transitioning (e.g., automatically (e.g., without user input)) from outputting audio content 740 in the second mode of output to the first mode of output in accordance with one or more criteria being satisfied (e.g., corresponding to cessation of movement in environment 700) conserves computing resources by outputting audio content 740 in the second mode of output (e.g., which incorporates changing a respective simulated source location of audio content 740 to maintain a fixed spatial relationship during movement) only when it is necessary (e.g., to avoid unintended acoustic effects) and/or desired by user 704 (e.g., to maintain output of audio content 740 during user movement).

As shown in FIG. 7E, audio content 740 is output from simulated source location 706e. In some examples, when transitioning from outputting audio content 740 from the second mode to the first mode, electronic device 701 maintains the current simulated source location of audio content 740 (e.g., simulated source location 706e corresponds to the respective simulated source location audio content 740 was output from in environment 702 when the one or more criteria were satisfied). For example, as shown in FIG. 7E, simulated source location 706e includes distance 718a and orientation 720a relative to first portion 708 (e.g., because user 704 has not changed pose since the transition of the output of audio content 740 from the second mode to the first mode). In some examples, when transitioning from outputting audio content 740 from the second mode to the first mode, electronic device 701 outputs audio content 740 from a respective simulated source location that includes the same spatial relationship with the electronic device 701 and/or first portion 708 as when audio content 740 was last output from in the first mode (e.g., prior to the output of audio content 740 in the second mode). For example, simulated source location 706e includes the same spatial relationship relative to the current pose of electronic device 701 in FIG. 7E as the spatial relationship between simulated source location 706a and the pose of electronic device 701 in FIG. 7A (e.g., when audio content 740 was last output in the first mode)). Additionally, or alternatively, in some examples, when transitioning from the second mode to the first mode, electronic device 701 outputs audio content 740 from a simulated source location corresponding to a direction indicated by one or more input devices of electronic device 701 (e.g., when output of audio content 740 was initiated in environment 702, or while the one or more criteria are satisfied (e.g., electronic device 701 outputs audio content 740 from a location corresponding to a direction of gaze of user 704 when the one or more criteria are satisfied)). Additionally, or alternatively, in some examples, when transitioning from the second mode to the first mode, electronic device 701 outputs audio content 740 from a simulated source location corresponds to a previous content recentering action (e.g., as described with reference to FIGS. 5G-5H). For example, the previous content recentering action occurred during the last time audio content 740 was output in the first mode. Additionally, or alternatively, in some examples, when transitioning from the second mode to the first mode, electronic device 701 performs a content recentering action (e.g., as described with reference to FIGS. 5G-5H). For example, the respective simulated source location electronic device 701 outputs audio content 740 from is centered relative to a current pose of electronic device 701 when the one or more criteria are satisfied. In some examples, electronic device 701 defines simulated source location 706e from information stored in a memory (e.g., a user-defined and/or preferred simulated source location for outputting audio content 740 in the first mode that is stored in a user profile).

Identifying (e.g., automatically) a simulated source location of audio content 740 when transitioning from the second mode of output to the first mode of output conserves computing resources associated with additional inputs to (e.g., manually) set the respective simulated source location of audio content 740 after user 704 (and electronic device 701) ceases movement in environment 700.

FIG. 7F illustrates electronic device 701 maintaining output of audio content 740 from simulated source location 706e in response to a change in pose of electronic device 701 that does not exceed threshold 712b according to examples of the disclosure. In some examples, in the first mode of output of audio content 740, electronic device 701 does not maintain a fixed spatial relationship between a current simulated source location of audio content 740 (e.g., simulated source location 706e shown in FIG. 7F) and first portion 708 (e.g., in the first mode, a distance and/or orientation of the current simulated source location is not locked relative to the torso of user 704). As shown in FIG. 7F, user 704 moves relative to environment 702 (from the position of user 704 shown in FIG. 7E) such that a current pose of electronic device 701 and first portion 708 changes (e.g., user 704 moves backwards and turns their body (e.g., torso) toward their right). In some examples, in the first mode, electronic device 701 maintains output of audio content 740 from a stationary location in environment 702 (e.g., user 704 is permitted six degrees-of-freedom relative to simulated source location 706e in FIGS. 7E-7F (e.g., if the movement of user 704 is within threshold 712b)). Accordingly, the spatial relationship between simulated source location 706e and first portion 708 changes when user 704 moves (e.g., when the current pose of electronic device 701 changes) by less than threshold 712b. For example, as shown in FIG. 7F, simulated source location 706e includes a distance 718b (shown as d2) and an orientation 720b (shown as theta 2) relative to first portion 708 that is different from distance 718a and orientation 720b shown in FIG. 7E (e.g., prior to the movement of user 704 in FIG. 7F). In some examples, in FIG. 7F, electronic device 701 outputs audio content 740 (e.g., using audio output devices 716a-716b) with acoustic properties and/or volume distribution that are different from the output of audio content 740 in FIG. 7E (because the spatial relationship between the current pose of electronic device 701 and simulated source location 706e is different in FIG. 7F compared to FIG. 7E).

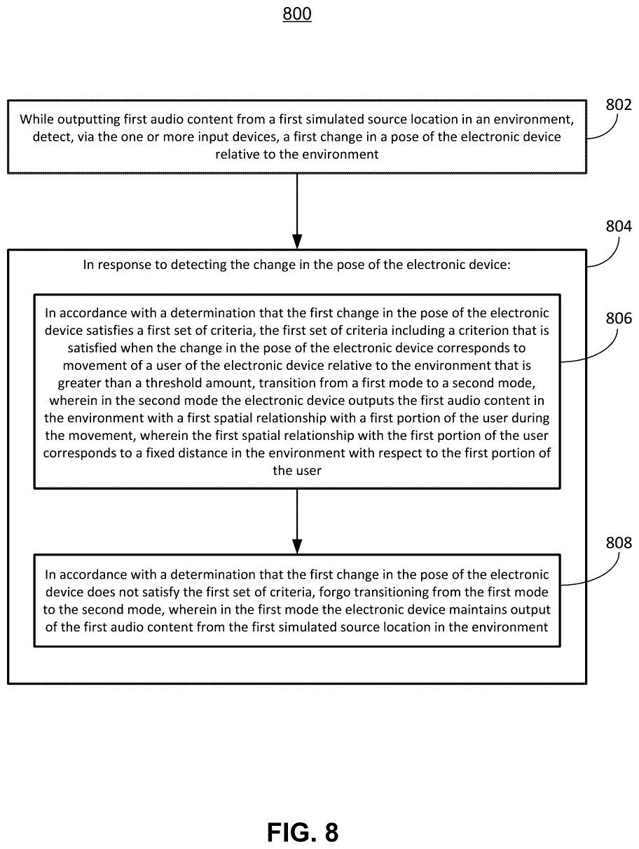

FIG. 8 illustrates a flow diagram for method 800 of updating a simulated source location of audio content in an environment during a change in pose of the electronic device according to examples of the disclosure. In some examples, method 800 begins at an electronic device in communication with (e.g., including or communicating signals with) an audio output device. In some examples, the electronic device is optionally a head-mounted device similar to or corresponding to electronic device 201 of FIG. 2, and the audio output device corresponds to one or more speakers included in the electronic device, such as speakers 216 of FIG. 2. In some examples, the electronic device is another type of device, such as a phone, tablet, laptop computer, audio transceiver, or television, and the audio output device includes headphones or earbuds in communication with the electronic device.

At block 802, while outputting a first audio content from a first simulated source location in an environment, the electronic device detects, via the one or more input devices, a first change in a pose of the electronic device relative to the environment. For example, the first change in pose of the electronic device includes a change of location and/or orientation of the electronic device relative to the environment (e.g., caused by movement of a user of the electronic device in the environment), such as the change in pose of electronic device 701 shown from FIG. 7A to FIG. 7B.

At block 804, in response to detecting the change in the pose of the electronic device, in accordance with a determination that the first change in the pose of the electronic device satisfies a first set of criteria, the first set of criteria including a criterion that is satisfied when the change in the pose of the electronic device corresponds to movement of a user of the electronic device relative to the environment that is greater than a threshold amount, the electronic device, at block 806, transitions from a first mode to a second mode, wherein in the second mode the electronic device outputs the first audio content in the environment with a first spatial relationship with a first portion of the user during the movement, wherein the first spatial relationship with the first portion of the user corresponds to a fixed distance in the environment with respect to the first portion of the user. In some examples, the first set of criteria corresponds to movement of user 704 (e.g., and electronic device 701) that exceeds threshold 712a shown in FIG. 7B. In some examples, the first portion of the user corresponds to a torso of the user (e.g., the user's chest, waist, abdomen, and/or other portions of the user's body apart from the head). In some examples, the first spatial relationship corresponds to the fixed spatial relationship described with reference to FIGS. 7B-7D. For example, the first spatial relationship includes a fixed distance (e.g., distance 718a shown in FIG. 7B) relative to the first portion of the user (e.g., and optionally a fixed orientation relative to the first portion of the user, such as orientation 720a shown in FIG. 7B). In some examples, in response to continued movement of user (e.g., and of the electronic device) in the environment, the electronic device maintains the first spatial relationship between the first audio content (e.g., the current simulated source location of the first audio content) and the first portion of the user (e.g., as shown during the continued movement of user 704 shown in FIGS. 7C-7D).

At block 808, in accordance with a determination that the first change in the pose of the electronic device does not satisfy the first set of criteria, the electronic device forgoes transitioning from the first mode to the second mode, wherein in the first mode the electronic device maintains output of the first audio content from the first simulated source location in the environment. For example, as shown in FIG. 7F, electronic device 701 does not transition from the first mode to the second mode in response to movement of user 704 (causing a change in pose of electronic device 701) that does not exceed threshold 712b. For example, as shown in FIG. 7F, outputting audio content 740 in the first mode includes maintaining output of audio content 740 at simulated source location 706e such that the spatial relationship between first portion 708 and simulated source location 706e of audio content 740 changes (e.g., from the spatial relationship between first portion 708 and simulated source location 706e shown in FIG. 7E).

Therefore, according to the above, some examples of the disclosure are directed to a method that includes, while outputting a first audio source from a first simulated source location in an environment, the first simulated source location having a first spatial relationship with a first pose of the audio output device in the environment, detecting a change in a pose of the audio output device from the first pose in the environment to a second pose in the environment different from the first pose.

In some examples, the method includes, in response to detecting the change in the pose of the audio output device and in accordance with a determination that the change in the pose of the audio output device satisfies a first set of criteria, including a criterion that is satisfied when the change in the pose of the audio output device is greater than a threshold amount of change, transitioning, over a first time duration, from outputting the first audio source from the first simulated source location to outputting the first audio source from a second simulated source location in the environment, the second simulated source location having the first spatial relationship with the second pose of the audio output device, the second simulated source location different from the first simulated source location.

In some examples, the method includes, in response to detecting the change in the pose of the audio output device and in accordance with a determination that the change in the pose of the audio output device does not satisfy the first set of criteria, continuing to output the first audio source from the first simulated source location.

In some examples, transitioning from outputting the first audio source from the first simulated source location to outputting the first audio source from the second simulated source location comprises fading out the first audio source at the first simulated source location and fading in the first audio source at the second simulated source location.

In some examples, transitioning from outputting the first audio source from the first simulated source location to outputting the first audio source from the second simulated source location comprises simulating an auditory movement of the first audio source from the first simulated source location to the second simulated source location.

In some examples, simulating the auditory movement comprises simulating the auditory movement along a curved path between the first simulated source location and the second simulated source location, wherein the path does not intersect the second pose of the audio output device.

In some examples, simulating the auditory movement comprises simulating the auditory movement along a line from the first simulated source location to the second simulated source location.

In some examples, the method includes, while outputting the first audio source from the first simulated source location in the environment, outputting a second audio source from a third simulated source location in the environment, the third simulated source location having a second spatial relationship with the first pose of the audio output device in the environment.

In some examples, the method includes, in accordance with the determination that the change in the pose of the audio output device satisfies the first set of criteria, transitioning, over the first time duration, from outputting the second audio source from the third simulated source location to outputting the second audio source from a fourth simulated source location in the environment while concurrently transitioning from outputting the first audio source from the first simulated source location to outputting the first audio source from a second simulated source, wherein the fourth simulated source location has the second spatial relationship with the second pose of the audio output device and the fourth simulated source location is different from the third simulated source location.

In some examples, the method includes, in accordance with a determination that the change in the pose of the audio output device does not satisfy the first set of criteria, continuing to output the second audio source from the third simulated source location.

In some examples, a spatial relationship between the first audio source and the second audio source is maintained during the transitioning.

In some examples, transitioning from outputting the first audio source from the first simulated source location to outputting the first audio source from the second simulated source location, and transitioning from outputting the second audio source from the third simulated source location to outputting the second audio source from the fourth simulated source location comprises simulating a rotation of the first audio source and second audio source as a group.

In some examples, the threshold amount of change comprises a threshold distance. In some examples, the threshold amount of change comprises a threshold amount of rotation. In some examples, the threshold amount of change comprises a change in a physical room in which the audio output device is located. In some examples, the threshold amount of change comprises a combination of the threshold distance, the threshold amount of rotation, and/or the change in the physical room in which the audio output device is located.

In some examples, the first pose of the audio output device comprises a first location of the audio output device in the environment. In some examples, the first pose of the audio output device comprises a first orientation of the audio output device in the environment.

In some examples, outputting the first audio source comprises at least one of transmitting the first audio source and transducing the first audio source.

In some examples, the first set of criteria includes a criterion that is satisfied when the audio output device remains in the second pose for a first threshold time duration.

In some examples, the first set of criteria includes a criterion that is satisfied when a simulated location of the first audio source has remained at the first source location for a second threshold time duration.

Some examples of the disclosure are directed to a method that includes, detecting, via one or more input devices, a first input corresponding to a request to output first audio content in an environment. In some examples, the method includes, in response to detecting the first input, outputting, via an audio output device, the first audio content from a first simulated source location in the environment, the first simulated source location corresponding to a direction indicated by at least a portion of the one or more input devices. In some examples, the method includes, while outputting the first audio content from the first simulated source location in the environment, detecting, via the one or more input devices, a second input. In some examples, the method includes, in response to detecting the second input, performing a content recentering action, the content recentering action including outputting the first audio content from a second simulated source location, different from the first simulated source location, in the environment.

In some examples, the method includes, while detecting the first input, presenting, via the one or more displays, a virtual object associated with the first audio content.

In some examples, the method includes, while outputting the first audio content from the first simulated source location in the environment, detecting an input corresponding to a request to move the virtual object associated with the first audio content from a first location in the environment to a second location, different from the first location, in the environment, wherein the first location corresponds to the first simulated source location. In some examples, the method includes, in response to detecting the input corresponding to the request to move the virtual object, moving the virtual object to the second location in the environment and maintaining output of the first audio content from the first simulated source location in the environment.

In some examples, the content recentering action includes moving the virtual object associated with the first audio content from a first location in the environment to a second location in the environment, wherein the second location in the environment corresponds to the second simulated source location.

In some examples, the method includes, while outputting the first audio content from the second simulated source location in the environment, detecting a change in pose of the electronic device relative to the environment. In some examples, the method includes, in response to detecting the change in pose of the electronic device, maintaining outputting the first audio content from the second simulated source location in the environment.

In some examples, the first simulated source location is a fixed distance from the electronic device relative to the environment.

In some examples, the second simulated source location is the fixed distance from the electronic device relative to the environment.

In some examples, the direction indicated by the at least the portion of the one or more input devices corresponds to a pose of the electronic device relative to the environment.

In some examples, the direction indicated by the at least the portion of the one or more input devices corresponds to a direction of gaze of a user of the electronic device.

In some examples, the one or more input devices includes a hardware input device, and the second input is provided through the hardware input device.

In some examples, the second input corresponds to a change in pose of the electronic device from a first pose in the environment to a second pose in the environment that satisfies a first set of criteria, the first set of criteria including a first criterion that is satisfied when the change in the pose of the electronic device is greater than a threshold amount of change.

In some examples, the first set of criteria includes a second criterion that is satisfied when, after the first criterion is satisfied, the electronic device remains in the second pose for a threshold time duration.

In some examples, outputting the first audio content from the second simulated source location in the environment includes transitioning, via the audio output device, from outputting the first audio content from the first simulated source location in the environment to outputting the first audio content from the second simulated source location in the environment.

In some examples, transitioning from outputting the first audio content from the first simulated source location in the environment to outputting the first audio content from the second simulated source location in the environment includes simulating auditory movement along a curved path between the first simulated source location to the second simulated source location, wherein the curved path does not intersect a location corresponding to the electronic device in the environment.

In some examples, transitioning from outputting the first audio content from the first simulated source location in the environment to outputting the first audio content from the second simulated source location in the environment includes fading out the first audio content at the first simulated source location and fading in the first audio content at the second simulated source location.

In some examples, transitioning from outputting the first audio content from the first simulated source location in the environment to outputting the first audio content from the second simulated source location in the environment includes, in accordance with a determination that the second input is provided in a first manner, transitioning from outputting the first audio content from the first simulated source location in the environment to outputting the first audio content from the second simulated source location in the environment over a first time duration. In some examples, transitioning from outputting the first audio content from the first simulated source location in the environment to outputting the first audio content from the second simulated source location in the environment includes, in accordance with a determination that the second input in a second manner, different from the first manner, transitioning from outputting the first audio content from the first simulated source location in the environment to outputting the first audio content from the second simulated source location in the environment over a second time duration, greater than the first time duration.

Some examples of the disclosure are directed to a method that includes, while outputting a first audio content from a first simulated source location in an environment, detecting, via one or more input devices, a first change in a pose of the electronic device relative to the environment. In some examples, the method includes, in response to detecting the first change in the pose of the electronic device, in accordance with a determination that the first change in the pose of the electronic device satisfies a first set of criteria, the first set of criteria including a criterion that is satisfied when the first change in the pose of the electronic device corresponds to movement of a user of the electronic device relative to the environment that is greater than a threshold amount, transitioning from a first mode to a second mode, wherein in the second mode the electronic device outputs the first audio content in the environment with a first spatial relationship with a first portion of the user during the movement, and wherein the first spatial relationship with the first portion of the user corresponds to a fixed distance in the environment with respect to the first portion of the user. In some examples, the method includes, in response to detecting the first change in the pose of the electronic device, in accordance with a determination that the first change in the pose of the electronic device does not satisfy the first set of criteria, forgoing transitioning from the first mode to the second mode, wherein in the first mode the electronic device maintains output of the first audio content from the first simulated source location in the environment.

In some examples, the first portion of the user corresponds to a torso of the user.

In some examples, the first spatial relationship with the first portion of the user corresponds to a fixed orientation in the environment with respect to the first portion of the user.

In some examples, the threshold amount includes a threshold distance.

In some examples, the threshold distance corresponds to a distance between a first region of a physical environment of the user, the first region including a location of the electronic device prior to the movement of the user, to a second region of the physical environment different from the first region.

In some examples, the method includes, while outputting the first audio content in the environment in the second mode, detecting cessation of movement of the electronic device relative to the environment. In some examples, the method includes, in response to detecting the cessation of the movement of the electronic device, in accordance with a determination that the cessation of the movement of the electronic device satisfies a second set of criteria, transitioning from the second mode to the first mode, wherein in the first mode the electronic device outputs the first audio content from a second simulated source location in the environment.

In some examples, the first simulated source location has a second spatial relationship with a first pose of the electronic device and the second simulated source location has the second spatial relationship with a second pose of the electronic device different from the first pose.

In some examples, the second simulated source location corresponds to a direction indicated by at least a portion of the one or more input devices of the electronic device when output of the first audio content in the environment is initiated.

In some examples, the second simulated source location is associated with a content recentering action performed by the electronic device.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method, comprising:
at an electronic device in communication with an audio output device:
while outputting a first audio source from a first simulated source location in an environment, the first simulated source location having a first spatial relationship with a first pose of the audio output device in the environment, detecting a change in a pose of the audio output device from the first pose in the environment to a second pose in the environment different from the first pose; and
in response to detecting the change in the pose of the audio output device:
in accordance with a determination that the change in the pose of the audio output device satisfies a first set of criteria, including a criterion that is satisfied when the change in the pose of the audio output device is greater than a threshold amount of change, transitioning, over a first time duration, from outputting the first audio source from the first simulated source location to outputting the first audio source from a second simulated source location in the environment, the second simulated source location having the first spatial relationship with the second pose of the audio output device, the second simulated source location different from the first simulated source location, and
in accordance with a determination that the change in the pose of the audio output device does not satisfy the first set of criteria, continuing to output the first audio source from the first simulated source location.

2. The method of claim 1, wherein transitioning from outputting the first audio source from the first simulated source location to outputting the first audio source from the second simulated source location comprises fading out the first audio source at the first simulated source location and fading in the first audio source at the second simulated source location.

3. The method of claim 1, wherein transitioning from outputting the first audio source from the first simulated source location to outputting the first audio source from the second simulated source location comprises simulating an auditory movement of the first audio source from the first simulated source location to the second simulated source location.

4. The method of claim 1, further comprising:
while outputting the first audio source from the first simulated source location in the environment, outputting a second audio source from a third simulated source location in the environment, the third simulated source location having a second spatial relationship with the first pose of the audio output device in the environment;
in accordance with the determination that the change in the pose of the audio output device satisfies the first set of criteria, transitioning, over the first time duration, from outputting the second audio source from the third simulated source location to outputting the second audio source from a fourth simulated source location in the environment while concurrently transitioning from outputting the first audio source from the first simulated source location to outputting the first audio source from a second simulated source, wherein the fourth simulated source location has the second spatial relationship with the second pose of the audio output device and the fourth simulated source location is different from the third simulated source location; and
in accordance with the determination that the change in the pose of the audio output device does not satisfy the first set of criteria, continuing to output the second audio source from the third simulated source location.

5. The method of claim 4, wherein a spatial relationship between the first audio source and the second audio source is maintained during the transitioning.

6. The method of claim 1, wherein the threshold amount of change comprises a threshold distance.

7. The method of claim 1, wherein the threshold amount of change comprises a threshold amount of rotation.

8. The method of claim 1, wherein the first set of criteria includes a criterion that is satisfied when the audio output device remains in the second pose for a first threshold time duration.

9. An electronic device comprising:
one or more processors;
memory; and
one or more programs stored in the memory and configured to be executed by the one or more processors, the one or more programs including instructions for performing a method of comprising:
while outputting a first audio source from a first simulated source location in an environment, the first simulated source location having a first spatial relationship with a first pose of an audio output device of the electronic device in the environment, detecting a change in a pose of the audio output device from the first pose in the environment to a second pose in the environment different from the first pose; and
in response to detecting the change in the pose of the audio output device:
in accordance with a determination that the change in the pose of the audio output device satisfies a first set of criteria, including a criterion that is satisfied when the change in the pose of the audio output device is greater than a threshold amount of change, transitioning, over a first time duration, from outputting the first audio source from the first simulated source location to outputting the first audio source from a second simulated source location in the environment, the second simulated source location having the first spatial relationship with the second pose of the audio output device, the second simulated source location different from the first simulated source location, and
in accordance with a determination that the change in the pose of the audio output device does not satisfy the first set of criteria, continuing to output the first audio source from the first simulated source location.

10. The electronic device of claim 9, wherein transitioning from outputting the first audio source from the first simulated source location to outputting the first audio source from the second simulated source location comprises fading out the first audio source at the first simulated source location and fading in the first audio source at the second simulated source location.

11. The electronic device of claim 9, wherein transitioning from outputting the first audio source from the first simulated source location to outputting the first audio source from the second simulated source location comprises simulating an auditory movement of the first audio source from the first simulated source location to the second simulated source location.

12. The electronic device of claim 9, wherein the method further comprises:
while outputting the first audio source from the first simulated source location in the environment, outputting a second audio source from a third simulated source location in the environment, the third simulated source location having a second spatial relationship with the first pose of the audio output device in the environment;
in accordance with the determination that the change in the pose of the audio output device satisfies the first set of criteria, transitioning, over the first time duration, from outputting the second audio source from the third simulated source location to outputting the second audio source from a fourth simulated source location in the environment while concurrently transitioning from outputting the first audio source from the first simulated source location to outputting the first audio source from a second simulated source, wherein the fourth simulated source location has the second spatial relationship with the second pose of the audio output device and the fourth simulated source location is different from the third simulated source location; and
in accordance with the determination that the change in the pose of the audio output device does not satisfy the first set of criteria, continuing to output the second audio source from the third simulated source location.

13. The electronic device of claim 12, wherein a spatial relationship between the first audio source and the second audio source is maintained during the transitioning.

14. The electronic device of claim 9, wherein the threshold amount of change comprises a threshold distance.

15. The electronic device of claim 9, wherein the threshold amount of change comprises a threshold amount of rotation.

16. The electronic device of claim 9, wherein the first set of criteria includes a criterion that is satisfied when the audio output device remains in the second pose for a first threshold time duration.

17. A non-transitory computer readable storage medium storing one or more programs, the one or more programs comprising instructions, which when executed by one or more processors of an electronic device, cause the electronic device to perform a method comprising:
while outputting a first audio source from a first simulated source location in an environment, the first simulated source location having a first spatial relationship with a first pose of an audio output device of the electronic device in the environment, detecting a change in a pose of the audio output device from the first pose in the environment to a second pose in the environment different from the first pose; and
in response to detecting the change in the pose of the audio output device:
in accordance with a determination that the change in the pose of the audio output device satisfies a first set of criteria, including a criterion that is satisfied when the change in the pose of the audio output device is greater than a threshold amount of change, transitioning, over a first time duration, from outputting the first audio source from the first simulated source location to outputting the first audio source from a second simulated source location in the environment, the second simulated source location having the first spatial relationship with the second pose of the audio output device, the second simulated source location different from the first simulated source location, and
in accordance with a determination that the change in the pose of the audio output device does not satisfy the first set of criteria, continuing to output the first audio source from the first simulated source location.

18. The non-transitory computer readable storage medium of claim 17, wherein transitioning from outputting the first audio source from the first simulated source location to outputting the first audio source from the second simulated source location comprises fading out the first audio source at the first simulated source location and fading in the first audio source at the second simulated source location.

19. The non-transitory computer readable storage medium of claim 17, wherein transitioning from outputting the first audio source from the first simulated source location to outputting the first audio source from the second simulated source location comprises simulating an auditory movement of the first audio source from the first simulated source location to the second simulated source location.

20. The non-transitory computer readable storage medium of claim 17, wherein the method further comprises:
while outputting the first audio source from the first simulated source location in the environment, outputting a second audio source from a third simulated source location in the environment, the third simulated source location having a second spatial relationship with the first pose of the audio output device in the environment;
in accordance with the determination that the change in the pose of the audio output device satisfies the first set of criteria, transitioning, over the first time duration, from outputting the second audio source from the third simulated source location to outputting the second audio source from a fourth simulated source location in the environment while concurrently transitioning from outputting the first audio source from the first simulated source location to outputting the first audio source from a second simulated source, wherein the fourth simulated source location has the second spatial relationship with the second pose of the audio output device and the fourth simulated source location is different from the third simulated source location; and
in accordance with the determination that the change in the pose of the audio output device does not satisfy the first set of criteria, continuing to output the second audio source from the third simulated source location.

21. The non-transitory computer readable storage medium of claim 20, wherein a spatial relationship between the first audio source and the second audio source is maintained during the transitioning.

22. The non-transitory computer readable storage medium of claim 17, wherein the threshold amount of change comprises a threshold distance.

23. The non-transitory computer readable storage medium of claim 17, wherein the threshold amount of change comprises a threshold amount of rotation.

24. The non-transitory computer readable storage medium of claim 17, wherein the first set of criteria includes a criterion that is satisfied when the audio output device remains in the second pose for a first threshold time duration.
